(19) United States
(12) Patent Application Publication
(10) Pub. No.: US 2023/0219272 A1
(43) Pub. Date: Jul. 13, 2023

(54) Low Haze Fluoropolymer Film and Method of Making

(71) Applicant: The Mackinac Technology Company, Kentwood, MI (US)

(72) Inventors: Attila Molnar, Vadnais Heights, MN (US); Anja Techel, Dresden (DE); David V. Tsu, Auburn Hills, MI (US); John Thomas Slagter, Grand Rapids, MI (US)

(73) Assignee: The Mackinac Technology Company, Kentwood, MI (US)

(21) Appl. No.: 17/927,691

(22) PCT Filed: Jul. 27, 2022
(86) PCT No.: PCT/US2021/043343

§ 371 Date: Nov. 23, 2022

Related U.S. Application Data
(60) Provisional application No. 63/030,865, filed on May 27, 2020.

(51) Int. Cl. B29C 48/00; B29C 71/02

(52) U.S. Cl. CPC B29C 48/0018; B29C 71/02; B29C 2071/022; B29K 2027/12

(57) ABSTRACT

An ETFE film that has a haze value of 2% or less, and preferably 1% or less, which advantageously may have a thickness greater than 150 pm, and preferably In the range of 200 pm to 300 pm, A film of ETFE, as received from the manufacturer, is stretched under special processing conditions to produce a processed (or final) film having an area stretch factor (Ax) greater than about 1.6. Ax —Initial film thickness/film thickness after stretching. However, it is important that the initial film thickness has a starting thickness of at least 400 pm, and preferably at least 500 pm. Processing conditions Include, in some embodiments, pre-beating and heating during stretching, and post-stretching annealing If the film is stretched in a 2.5×1 or a 4×1 ratio, at a processing temperature in THV range of 130° C. to 150° C., the haze of the resulting film can be reliably brought down to less than 2%. We have also found that this low haze value is not dependent on whether the larger stretch {e.g., 2,5× or 4×) is in the machine direction (MD) or the transverse direction (TD) of the extruded film. Annealing the stretched film decreases the film shrinkage to almost 0%.

### RELATIONSHIP TO OTHER APPLICATION

This application claims the benefit of the filing date of U.S. Provisional Patent Application Ser. No. 63/030865 filed May 27, 2020, Conf. No. 7865 (Foreign Filing License Granted). The disclosure in the identified United States Provisional Patent Application is incorporated herein by reference.

### BACKGROUND OF THE INVENTION

### Field of the Invention

This invention relates generally to polymer films, and more particularly, to fluoropolymer films that have excellent transparency and mechanical properties, and methods of making same using a stretching technique.

### Description of the Prior Art

Fluorocarbon-based polymers are advantageous for many applications due to their high resistance to solvents, acids, and bases. The best known fluoropolymer is, of course, polytetrafluoroethylene (PTFE; sold under the trademark Teflon by The Chemours Company FC, LLC (formerly Dupont), Other widely-known fluorocarbon-based polymers include, polyvinylfluoride (PVF), polychlorotrifluoroethylene, fluorinated ethylene-propylene (FEP), polyvinylidene difluoride (PVDF), perfluoroalkoxy polymer (PFA), and polyethylenetetrafluoroethylene (ETFE), among others.

ETFE is a fluoropolymer resin that consists essentially of an alternating sequence of ethylene (E) and tetrafluoroethylene (TFE) units. Even though the number of —CH₂ and —CF₂ units in ETFE are essentially the same as that for PVDF, the pairing of —CH₂ units and the pairing of —CF₂ units in the polymer backbone in ETFE results in a fluoropolymer with a very unique set of properties. While ETFE has found applications in the electronics, horticultural and chemical process industries due to its chemical resistance and non-stick properties, its use as an architectural film to provide a translucent, weatherable, non-flammable, and self-cleaning component to buildings is of particular relevance to the present invention. While PVDF has exceptionally good mechanical properties, it is much less translucent than ETFE and is also subject to chemical attack by alkaline substances, the latter leading to discoloration of the film. While some other fluoropolymers may also offer good light transmittance and chemical resistance (e.g., FEP, THV, PFA), the superior mechanical properties of ETFE have allowed ETFE to gain popularity for architectural applications.

ETFE (CAS # 68258-85-5) is a copolymer comprising 30-70 mole % ethylene, 30-70 mol % tetrafluoroethylene, and usually a small amount of a polymerizable vinyl termonomer such as perfluoroisobutylene, perfluoropropyl vinyl ether, hexafluoropropylene, and similar species that usually constitute less than 5 mol % of the polymer, The crystallinity typically ranges from 35 to 60% and it has a melting temperature of between about 225-275° C., depending on the co-monomer content and processing conditions.

ETFE film is typically extruded using a cast film process, Commercial films produced this way, and without surface treatment, have haze values that range from around 2.5% for 50 μm thick films to about 9% (or higher) for 250 μm thick films, as measured using the testing standards set forth in ASTM D1003 (see, American Society for Testing and Materials document titled “Standard Test Method for Haze and Luminous Transmittance of Transparent Plastics,” 2000 (ANSI/ASTM D1003-00)). Surface treatment typically is performed, however, to enhance the surface adhesion characteristics. The haze measurement of a transparent sample describes the amount of light scattered when light passes through a transparent sample. The lower the haze measurement value, the higher the clarity of the sample indicating fewer impurities. Haze will be described more completely below.

In architectural applications, the film thickness is usually from 200 to 300 μm thick in order to provide sufficient mechanical strength since the film is often placed under a tensile load or, in some cases, two films are bonded together and pneumatically inflated to create translucent and insulating “pillows.” In some applications, the relatively high haze of thick ETFE film is used to advantage in order to diffuse light from decorative lighting (e.g., LED lights, such as those found in the Beijing National Aquatics Center, (the Water Cube) Beijing, China) which is the largest ETFE-clad structure in the world with over 100,000 m² of ETFE pillows that are only 0.2 mm (1/125 of an inch) in total thickness. However, in many cases, there are architectural applications where it would be of significant interest and value to have a very low haze film so that it is possible to clearly see through the film which, in effect, should appear as transparent as a glass window. For this to be the case, an ETFE film of 200 to 300 μm, for example, thickness should have a haze value of less than about 2%, and preferably less than 1%.

It is known that quenching an extruded polymer film makes It possible to limit the crystallinity of the film to improve optical properties. Japanese Pubn. No. JP56127231A laid open on Feb. 6, 1986 by inventors Abe, et al. discloses a method for producing a flat fluororesin film that has excellent optical properties such as transparency and gloss. Molten fluororesin is extruded from a T-die with a cooling roll set to have a surface temperature of 80° C. to 140° C. Hot air, between 50° C. to 160° C., is then blown on the cooled and solidified resin.

It is also known that the crystallinity of ETFE can be decreased by the judicious incorporation of additional monomers in the polymer. Japanese Pubn. No. JP-A-2001-206913 laid open on Jul. 31, 2001 by inventors Yuai, et al. discloses a tetrafluoroethylene-ethylene copolymer having high light transmittance and low haze, and which is crystalline, and has a volume flow rate of 1 to 1000 mm³/sec. The copolymers disclosed in JP-A-2001-206913 have a ratio of (polymerization unit derived from tetrafluoroethylene) to (polymerization unit derived from ethylene) of 30/70 to 70/30 (molar ratio) and further contain 1 to 10 (mol %) of a polymerization unit derived from a vinyl ether represented by CF₂=CF—O—R. In this formula, R represents a C3-C12 alkyl group optionally containing 1 to 3 ether oxygen atoms

Similarly, U.S. Pat. No. 9,822,225 discloses the inclusion of 0.8 to 2.5 mol % of fluoroalkyl ethylene units of the formula CH₂═CX—Rf where X represents H or F, and Rf represents a fluoroalkyl group having 2 or more carbon atoms. In this manner, the crystallinity of the fluoropolymer is reduced thereby to 68% or less. In conjunction with special film extrusion conditions, ETFE films of 40 to 60 μm thickness have been produced having haze values ranging from 1.9 to 2.3%.

It is known in the art that certain physical properties of thermoplastic films, including tensile strength and modulus of elasticity, can be improved by stretching the film in a tenter-frame machine. A tenter-frame machine continuously stretches, simultaneously in two perpendicular directions, a temperature-conditioned film or sheet, imparting biaxial orientation. Alternatively, a tenter-frame machine can be used to stretch the polymer film in only one direction (monoaxial).

Tentering is usually done shortly downstream from the polymer sheet extruder, but can also be done on film or thin sheets that have been extruded, cooled, and wound into coils for storage, and then later reheated to be oriented by the tenter-frame machine. In the tenter frame process, clamps attached to endless chains grip the polymer sheet on both edges and, while accelerating in the direction of sheet travel (Machine Direction; MD) also moves outward from the longitudinal centerline (Transverse Direction; TD). In this manner, a relatively thick extruded sheet of polymer is heated to its softening point (not to its melting point) and is mechanically stretched by 300-400%. Stretching in the tenter frame process is usually 4.5:1 in the machine direction and 8.0:1 in the transverse direction, although these ratios are fully adjustable.

Tenter-frame technology has been used to improve the optical and mechanical properties of ultrathin films of ETFE. US Publication No. 2002-0086963 laid open on Jul. 25, 2002 by inventors, Higuchi, et. al. and US Publication No. 2002-098371 laid open on Jul. 4, 2002 by inventors Higuchi, et al. disclose biaxially stretching an ETFE film between two “assist films” to produce ETFE films of 25 to 40 μm thickness having improved mechanical and optical properties. The tensile modulus of these films are 3 GPa in both the machine direction (MD) and the transverse direction (TD). The light transmittance of the film, at a wavelength of 300 nm (visible range), is at least 90% for a 25 μm thick ETFE film.

Thin films, of course, are not usable for architectural purposes. It is, therefore, a goal of this invention to provide and produce ETFE film that has low haze and yet is thick enough for architectural purposes while retaining other positive attributes that makes ETFE so well-suited for architectural applications.

### SUMMARY OF THE INVENTION

We have found that fluoropolymer films, and in particular, ETFE films, can be processed to have a final thickness of 150 μm or more, and preferably 200 μm or more, with a haze value of 2% or less so that the film appears glass-like when the film is free of surface defects and is placed under tension, such as would be the case in many architectural applications.

While other fluoropolymer films may be processed in accordance with the principles of the invention, ETFE is particularly preferred due to its superior mechanical properties. FEP, for example, has been treated in accordance with the principles of the invention (see, FIGS. 19 and 20). While FEP is less expensive than ETFE, it is not as rigid as ETFE.

In one embodiment of the invention, an ETFE film that has low haze value (<2%, and in some cases, <1%) and is prepared by a stretching process which starts with a film having an initial thickness as provided by the manufacturer of the film. We have found that the best results are obtained when the initial thickness is of 400 μm or more, and preferably 500 μm or more. The initial film is subjected to stretching, illustratively as shown herein in a stretching device, such as tenter-frame machine. The tenter-frame machine continuously stretches, simultaneously in two perpendicular directions, a temperature-conditioned film or sheet, imparting biaxial orientation. Alternatively, the tenter-frame machine can be used to stretch the polymer film in only one direction (monoaxial).

Favorable haze values are obtained when stretching results in an area stretch factor (Ax) of >1.6. Ax is calculated as follows: Ax=initial film thickness/film thickness after stretching. For preferred embodiments, the film thickness after stretching (or final film thickness) is >150 μm, and preferably >200 μm. The most reliable (and best) results in terms of low haze occur when the initial film has a thickness of 400 μm or more.

The processed film has a unique structure. The near IR signature of the film is indicative of a reorganization of the molecular structure, and in particular is indicative of hydrogen-bonding (H-bonding) interactions which may be modified by the stretching process.

More specifically, the stretched ETFE film that has specific changes to the combination bands in the NIR, thus demonstrating unique structural changes on the molecular-scale. In relationship to the unstretched material condition, we can define a quantity (that characterizes the stretching state) that we call the “Coupling Distance” which shows just how far the NIR coupling has shifted beyond the coupling found in the unstretched state. As will be shown in the figures below, the peak positions of the combination bands of five are changed which indicates a structural change on a molecular scale. The strength of the bands has also changed in response to stretching.

As will be demonstrated below, there is a distinct relationship between the Coupling Distance and the [LARGE(%) and SMALL(%)] of the Combined scattering centers in the material comprising the stretched ETFE, When SMALL scattering changes, it means that there is a reduced number of small scattering centers, or that they are agglomerating, so as to become a LARGE scattering center. If the H bonding is changing, then the position of the atoms cause scattering. This supports the conclusion that the ETFE film of the present invention has a unique molecular structure.

In a method of making embodiment of the invention, the fluoropolymer film, which in specific preferred embodiments is ETFE, is subjected to stretching, illustratively in a teetering machine. Of course, other stretching processes include sequential stretching, blown film and similar continuous as well as batch processes can be used within the scope of the invention.

A tenter-frame machine receives the initial polymer film, for example, as a polymer web, which is driven forward through zones having specific temperatures at a rate of speed so that the film resides in the zone for a period of time sufficient to bring the film to temperature. Illustratively, there is at least a pre-heating zone and a stretching zone. In certain preferred embodiments, there is also an annealing zone, and of course, post-stretching zone(s) for cooling, surface treating, and winding the treated film into a roll. In some embodiments, there may be additional pre-heating and stretching zones, and even an additional annealing zone, through which the film being processed is exposed (sequential zones). In the stretching zone(s), the polymer film may be stretched in only one direction monoaxially (Machine Direction, MD) or biaxially outward from the longitudinal centerline (Transverse Direction; TD). In this manner, the relatively thick extruded sheet of polymer is heated to its softening point (not to its melting point) and is mechanically stretched by 160% to 400%.

In preferred embodiments, the stretching temperature ranges from about 120° C. to 180° C., and preferably from 130° C. to 160° C. Likewise, for the pre-heat. In some embodiments, the stretched film is annealed while still under tension at a temperature between about 120° C. and 200° C.

In a specific illustrative method embodiment of the invention, the transparent ETFE film is subjected to a process comprising the steps of:

heating an extruded film of ETFE having an initial thickness ranging from about 400 μm to 500 μm or more to a temperature between about 120° C. to 180° C., and preferably from about 130° C. to 160° C.

stretching the film to have an Ax>1.65 and a final film thickness of at least about 150 μm, and preferably greater than 200 μm. In some embodiments, there is a further step of annealing the stretched film in the stretched state in order to decrease the film shrinkage to almost 0% without the film developing higher haze. Annealing is preferably done at a temperature between 125° C. and 200° C.

In a specific embodiment, the process for producing a low Haze ETFE film comprises the steps of (a) heating the film to a temperature between 120° C. and 180° C., (b) stretching the film at this temperature in at least one direction to obtain an area expansion factor of at least 1.55, (c) allowing the film to cool in the stretched state to at most 90° C., and (d) allowing the film to cool to ambient temperature without being in the stretched state. There may, optionally, be an annealing step following the stretching step where the film in a stretched state is subjected to a temperature between 120° C. and 200° C. for at least 5 seconds.

### BRIEF DESCRIPTION OF THE DRAWINGS

Comprehension of the invention is facilitated by reading the following detailed description, in conjunction with the annexed drawing, in which:

FIG. 1 is a graphical representation of haze (%) as a function of film thickness (μm) for samples of ETFE as obtained from various manufacturers;

FIG. 2 is a graphical representation of the Haze of ETFE films of different initial starting thicknesses that were stretched under various conditions;

FIG. 3 is graphical representation wherein Haze values measured on ETFE films (unstretched and stretched) are plotted against the film thickness (μm);

FIG. 4 is a graphical representation of the calculated film area stretch factor (Ax) plotted against Haze (%) for 500 μm samples of ETFE;

FIG. 5 is a plot of normalized [T_{d}] signals from unprocessed ETFE (AGC) of various thicknesses plotted against wavenumber (2pi/nm)(data Set-A0: (1) 100 μm; (2) 205 μm; and (3) 515 μm);

FIG. 6 is a plot of normalized [T_{d}] signals from ETFE of various thicknesses that were processed, that is, stretched at 130° C. plotted against wavenumber (2pi/nm)(data Set-A2: (1) 515 μm, unstretched reference; (2) 450 μm; (3) 335 μm; and (4) 210 μm);

FIG. 7 is a graphical representation of the Combined signal obtained by the Parametric Power Law method described hereinbelow versus conventional Haze measurements taken a single wavelength is used;

FIG. 8 is a graphical representation of the LARGE and SMALL scattering centers for untreated EFTE samples plotted against the sample thickness in μm;

FIG. 9A and FIG. 9B are graphical representations that show in FIG. 9A scattering signals of LARGE and SMALL centers as a function of thickness (μm) with processing (FIG. 9A) and as percent of total scattering (FIG. 9B);

FIG. 10A and FIG. 10B are graphical representations that show SMALL radii (nm) as a function of thickness (μm) (FIG. 10A) and SMALL number density Na (cm³) as a function of thickness (μm) (FIG. 10B);

FIG. 11 is a graphical representation of changes to the relative scattering area Aₛₘ/Aₒ (cm²/cm²) as a function of processing thickness (μm);

FIG. 12A and FIG. 12B are schematic representations of a sample of a polymer, such as ETFE, designated “slab” which shows the path of light impinging on the slab and explains why the measured [T] signal drops with scattering;

FIG. 13 shows [R, T] plots as a function of wavelength (nm) for the unprocessed, or unstretched ETFE samples (Set A-0) having various thicknesses that were shown in the scatter plot of FIG. 5;

FIG. 14 shows plots of [R] and [T] signals as a function of wavelength (nm) for the stretched ETFE samples (Set A-2) shown in the scatter plot of FIG. 6;

FIG. 15 shows plots of the sum [R+T] signals for the unstretched ETFE (Set-A0) as a function of wavelength (nm) for the sample (Set A-0) shown in the scatter plot of FIG. 5;

FIG. 16 shows plots of the absorptance [A] signals as a function of wavelength (nm) for the unprocessed ETFE samples (Set A-0) shown in the scatter plot of FIG. 5;

FIG. 17 is a graphical representation of the measured absorptance at 550 nm wavelength [A₅₀₀] due to scatter loss versus the measured Haze for a large number of samples;

FIG. 18 is the NIR absorption spectrum as measured by the extinction coefficient [K] of untreated ETFE samples as received from: (1) Nowofol, 100 μm; (2) Daikin, 98 μm; (3) AGC, 100 μm; and (4) DuPont, 50 μm;

FIG. 19 shows the IR and NIR absorption spectra as measured by the extinction coefficient [K] of the following untreated samples of fiuorine-containing polymers: ETFE by AGC, 100 μm (3); ETFE from 3M (5); and FEP by 3M (6);

FIG. 20 is a graphical representation of the fundamental absorption modes in the IR region, as measured by the extinction coefficient [K] of the untreated fluorine-containing polymers, ETFE from 3M (5); and FEP by 3M (6);

FIG. 21 is a graphical representation of the fitting of absorption features in the NIR spectral region due to “overtone” and “combination” bands of vibrational modes (O/C) for untreated ETFE (AGC, 100 μm thick) wherein the lines are designated (1) raw extinction coefficient [K] data; (2) baseline adjustments; and (3) the fit;

FIG. 22 is a bar graph that shows fitting results for the O/C NR bands for samples of ETFE from various manufacturers at NIR band wavelengths (nm) as a function of charge density Nₑ(10¹⁵cm⁻³);

FIG. 23A and FIG. 23B shows the fitting results for the Set-of-5 combination bands of the 3M/Dyneon/Nowofol (FIG. 23A), and AGC (FIG. 238) samples, showing the amplitude of charge density Nₑ (10¹⁵cm⁻³) as a function of sample thickness (nm) for the Set-of-5 combination bands of the samples;

FIG. 24 is a graphical representation comparing the amplitude of the 2259 nm versus the 2411 nm bands of the Set-of-5 combination bands of the samples;

FIG. 25 is a plot of the measured refractive index [n] for untreated material from various manufactures at specific wavelengths (nm) wherein the lines on the plot are designated (1) Nowofol, 100 μm; (2) Daikin, ⁹⁸ μm; (3) AGC, 100 μm; and (4) DuPont, 50 μm;

FIG. 26 is a plot of the measured C/O absorption [K] (×0.0010) of ETFE by AGC, starting at 500 μm which is then stretched to have a stretch thickness ratio ® from about 1 to 0.042. The plot lines on FIG. 26 as designated as: (1) r=1.0 (unstretched); (2) r=0.90; (3) r=0,89; (4) r=0,67; (5) r=0.420; and (6) r=0.426;

FIG. 27A though FIG. 27D are NIR absorption plots of four of five Set-of-5 NIR band intensities (10¹⁵cm⁻³) versus the area stretch factor (Ax) of ETFE samples having different starting thicknesses (100 μm, 300 μm, and 500 μm). Open symbols are unstretched reference samples and the solid symbols are processed or stretched, samples as indicated on the legend;

FIG. 28A though FIG. 28D are plots of the NIR band intensities of an individual band in a Set-of-5 in relation to the band intensity of another band in the set-of-5;

FIG. 29A through FIG. 29C are plots of the NIP. 2259 nm band (10¹⁵cm⁻³) versus Haze for samples of ETFE having different starting thicknesses from 100 μm (FIG. 29A), 300 μm (FIG. 29B), and 500 μm (FIG. 29C);

FIGS. 29D through 29F are plots of the absolute change |Δ| in the 2259 band 10¹⁵ cm⁻³) versus Haze for the respective same samples as in FIG. 29A through FIG. 29C;

FIG. 30A and FIG. 30B are graphical representations of scatter percent by LARGE (FIG. 30A) and SMALL (FIG. 30B) centers plotted against their Coupling Distance (10¹⁵cm⁻³) for samples of ETFE as identified on the legends on the figures;

FIG. 31 shows the empirical parameters used to calculate the viscosity ratio for a comparison of laboratory process parameters versus production scale parameters; and

FIG. 32 is a graphical representation of Haze (%) versus the calculated film Area Stretch Factor (Ax).

### DETAILED DESCRIPTION

### 1) Experiments Related to Calculating Haze and Film Area Stretch Factor (Ax) for Specimens of ETFE

Haze is an optical effect caused by light scattering within a transparent polymer resulting in a cloudy or milky appearance. The lower the measured haze value, the higher the clarity of the sample. There are two types of haze, reflection haze (gloss) and transmission haze (clarity). Measurement and control of both types of haze during manufacturing ensures optimum quality of the end product.

When light strikes the surface of a transparent material, some will be reflected from the front surface of the material, some will be refracted within the material and reflected from the second surface, and some will pass through the material at an angle which is determined by the refractive index of the material and the angle of illumination (See, A and 12B). The light that passes through the transparent material can be affected by irregularities within the material, such as dispersed particles, contaminants (i.e. dust particles) and/or air spaces. This causes the light to scatter in different directions from the normal, the degree of which is related to the size and number of irregularities present. Small irregularities cause the light to scatter, or diffuse, in all directions while large ones cause the light to be scattered forward in a narrow cone shape. These two types of scattering behaviors are known as Wide Angle Scattering, which causes haze due to the loss of transmissive contrast, and Narrow Angle Scattering which cause a reduction in clarity.

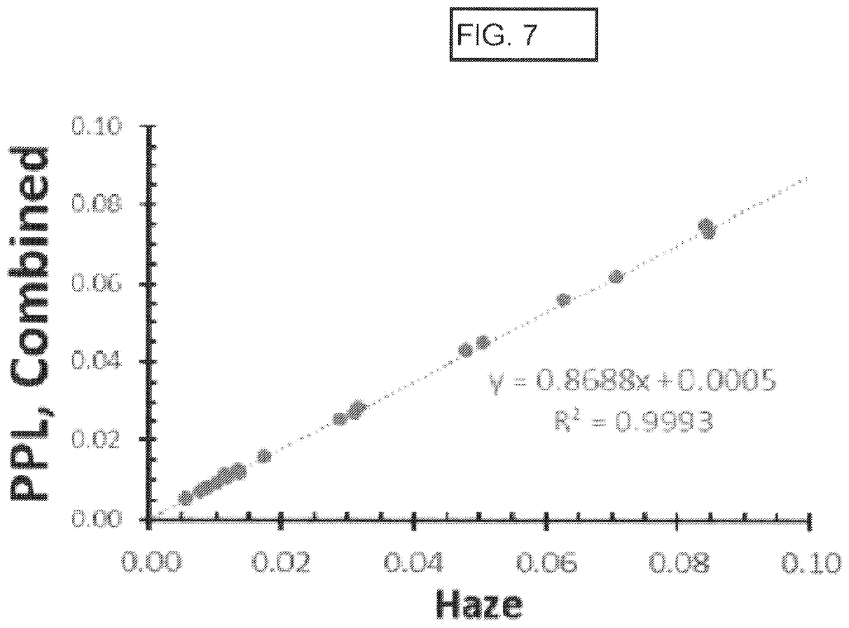

Haze is the amount of light that is subject to Wide Angle Scattering (at an angle greater than 2.5° from normal (ASTM D1003). Clarity is the amount of light that is subject to Narrow Area Scattering (at an angle less than 2.5° from normal). Of course, transmission is the amount of light that passes through the material without being scattered. Measurement of these factors is defined and determined according to two test methods (ASTM D1003): Procedure A—using a Haze meter; and Procedure B—using a Spectrophotometer. We have confirmed that the two methods of measuring haze produce equivalent results (see, FIG. 7 which shows that there is a 99% correlation).

The experiments reported herein, were conducted according to ASTM D1003 using a Haze-Gard haze meter available from Paul N. Gardner Company, Pompano Beach, Fla., and/or a Shimadzu UV 3600 spectrophotometer with an integrating sphere detector, available from Shimadzu, Kyoto, Japan to ascertain haze values

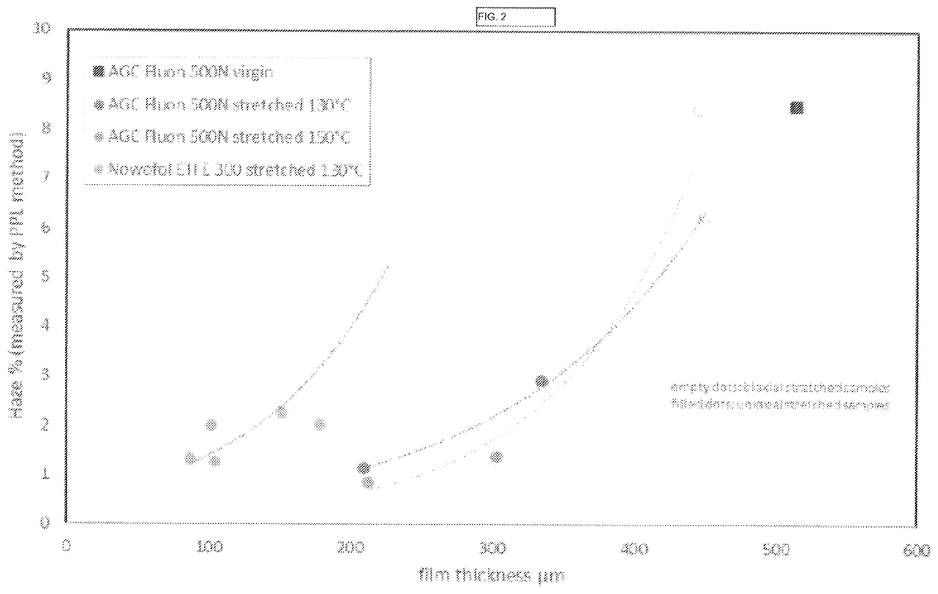

The data shown in FIGS. 2 to 30, were collected from fluoropolymer samples that had been processed using a laboratory scale stretching device, specifically a Karo IV stretching machine at Brückner Maschinenbau GmbH & Co. KG, Königsberger Str., 5-783313 Siegsdorf, Germany. Details of this machine can be seen at the following website: https://www.brueckner-maschinenbau.com).

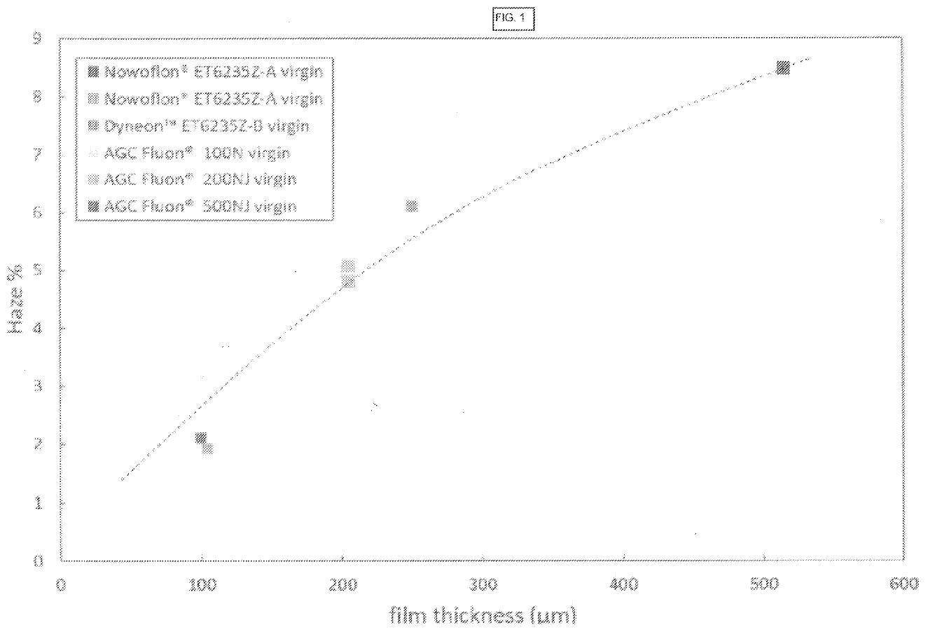

FIG. 1 shows haze data for ETFE samples as received (virgin; unprocessed) from various manufacturers. The specific samples used were: Nowoflon® ETFE available from NOWOFOL Kunststoffprodukte GmbH & Co., Breslauer Str. 15, 83313 Siegsdorf, Germany (two 100 μm thick samples; Nowofol Product Code No. ET6235Z-A); Dyneon® ETFE available upon request from 3M Company, 3M Center, 2501 Hudson Road, St. Paul, Minn. (one 250 μm thick sample); and Fluon® ETFE available from AGC Chemicals, Europe (Three samples; AGC Product Code Nos. 100N (100 μm thick, natural), 200NJ (200 μm thick, natural), and 500NJ (500 μm thick, natural, thick).

Referring to FIG. 1,which is a graphical representation of haze (%) as a function of sample thickness, it is clear that in order to obtain an ETFE film having a haze of around 1%, the ETFE film would have to be substantially thinner than 100 μm, and most likely, as thin as 50 μm, Even at 100 μm thick, ETFE film ranges from 2% to above 3% in haze. The information shown in FIG. 1 is important to keep in mind since the stretching of films leads to a concurrent thinning of the film and if haze is found to be reduced, it must be shown that it is not only because of the decrease in film thickness, but additionally because of the effects of a specific treatment of the film (by process) One of the goals of this invention is to produce films of sufficient thickness for architectural purposes that have a haze value of 2% or, less, and preferably 1% or less, so that the film appears glass-like.

FIG. 2 is a graphical representation of the haze of ETFE films of different initial starting thicknesses that were stretched biaxially (empty dots) and uniaxially (filled dots) at two different oven temperatures (130° C. or 150° C.) as indicated in the legend on FIG. 2. Haze % was measured by the Parametric Power Law (PPL) method described hereinbelow, The calculated haze of the stretched film decreased from 8% to 1%, while the thickness of the film went from 500 μm to 200 μm. The reduction of haze was lower when the temperature during biaxial stretching was 150° C. instead of 130° C., as shown in FIG. 2.

While reduction of the haze of ETFE film that is stretched through a tentering process can be achieved when the starting film thickness is 100 to 300 μm thick, we have surprisingly discovered that the reduction in haze is even greater when the starting material is of a thickness on the order of 500 μm or thicker. With the right tentering conditions, as will be described in the subsequent examples, the haze of ETFE film can be reduced to below 1% haze for a film of 213 μm in thickness. In contrast the tentering (biaxial stretching) of a 300 μm thick film reduced the film thickness to 87 μm to 179 μm with haze values between 1.2 to 2.2%. It can similarly be shown that it is difficult to produce films with haze of less than 1%, when the film is thinner at the start, despite the thinning out of the film by the stretching process. One would expect the thinner film to have the lower haze.

Those skilled in the art will know that the area stretching conditions of the stretching process (oven temperature, soak time before stretching (pre-heating), area stretching factor, oven temperature while stretching, stretching speed, and the like) can be adjusted such that there is a monotonic increase in the tensile stress vs. strain of the film while the film is being stretched. Such conditions for area stretching of ETFE film result in optimal flatness of the film and an optimal drop in haze.

For convenience, an area stretch factor (Ax) is calculated as follows:
Ax=initial film thickness/film thickness after stretching.

This factor is convenient because the target stretching values of the extruded films in the machine direction (MD) and transverse direction (TD) cannot always be used to establish the increase in surface area of the film. However the sample thickness can be accurately determined during spectroscopic analysis and, thus, Ax for the sample film can be accurately determined through the above relationship. It is assumed that the polymer film has a Poisson's ratio of 0.5. This assumption implies that there is no net increase (or decrease) of a unit volume of the film material during stretching. This is close to what could be expected since the stretching process occurs in the rubbery plateau region of the material, that is, between its glass transition temperature, T_{g}, and its crystalline melting temperature, Tₘ. Moreover, it is generally known that elastomers typically have a Poisson's ratio of 0.5.

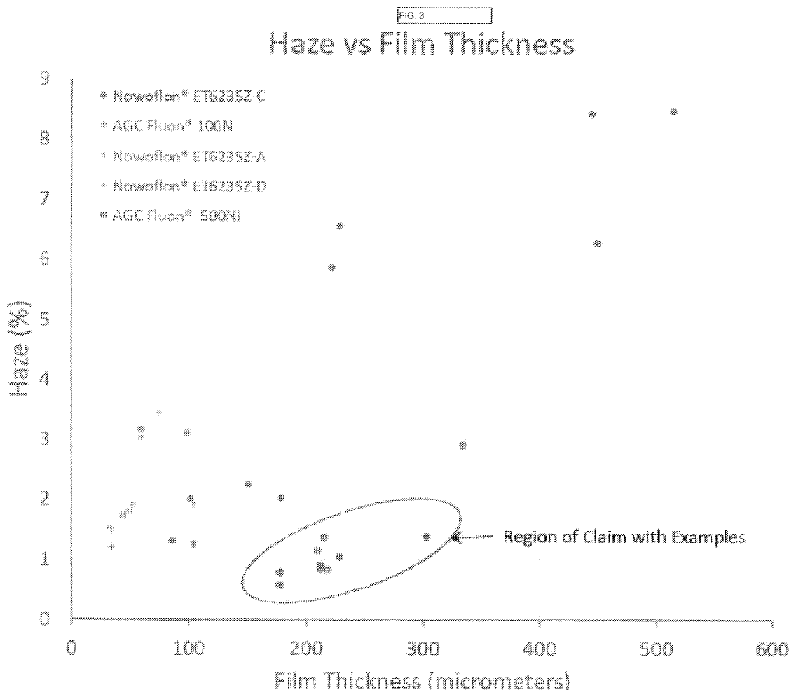

One would expect that more light will go through, and the haze value will be less, for a thinner film, as shown in FIG. 1. It follows then that one would expect that the higher the Ax, the thinner the film produced, with a correspondingly lower haze. Referring to FIG. 3, however, we have found an area of lower haze than would be normally anticipated when considering the thickness of these films.

FIG. 3 is graphical representation wherein haze values measured on ETFE films (unstretched and stretched) are plotted against the film thickness (μm). The circled region on the plot shows that some relatively thick films were produced that had haze values of approximately 1% or less. These films were stretched with Ax>1.65 and had a final film thickness>175 μm.

The following specific and comparative examples were used to collect the data reported in Table 1.

### EXAMPLE 1

A 9 cm square piece of a 500 micrometer (μm) thick film of ETFE (Fluon 500N, obtained from AGC Chemicals Europe) was placed into the stretching frame of a laboratory stretching device and heated to a temperature of 150° C. in the oven. After an equilibration time, the film was then stretched at 150° C. to a target 2.5×1 (MD×TD) stretching ratio, where MD refers to the machine direction, and TD to the transverse direction of the extruded film) at a rate of 100%/sec. The sample was then allowed to cool and removed from the device for evaluation, Some “necking,” or narrowing, in the TD width was noted between the holding clips (tenters). The sample was then tested for Haze according to the method described below. The spectroscopic analysis for the Haze determination also allowed the sample thickness to be accurately determined. From this sample thickness, the Area stretch factor (Ax) was calculated. The Ax value provides a more accurate indication of the film area expansion at the location where the spectroscopic measurements were taken as compared to merely using the stretch ratios, since the “necking” of the film between the clips reduces the true area stretch. For the calculation of Ax_{;} it was assumed that the Poisson's ratio of the ETFE film is 0.5 during the stretching process, i.e., there is no volumetric expansion or contraction of the sample during the stretching process.

### EXAMPLE 2

The same procedure was used as in Example 1 except that the film had a target stretching ratio of 4×1 (MD×TD).

### EXAMPLE 3

The same procedure was used as in Example 2 except that the film was heated to 130° C. for stretching and the annealing oven was set to 130° C.

### EXAMPLE 4

The same procedure was used as in Example 3 except that a 7 cm square piece of film for stretching was obtained about 10 cm from the first edge of a 1.1 meter wide roll of film.

### EXAMPLE 5

The same procedure was used as in Example 3 except that a 7 cm square piece of film for stretching was obtained about 10 cm from the second edge of the 1.1 meter roll of film (the edge opposite to that of Example 4).

### EXAMPLE 6

The same procedure was used as in Example 3 except that a 7 cm square piece of film for stretching was obtained from the center of the 1.1 meter roll of film.

### EXAMPLE 7

The same procedure was used as in Example 4 except that the film was stretched 1×4 (MD×TD), This means that the film was stretched more in the transverse direction of the extruded film.

### EXAMPLE 8

The same procedure was used as in Example 5 except that the film was stretched 1×4 (MD×TD). This means that the film was stretched more in the transverse direction of the extruded film.

### EXAMPLE 9

The same procedure was used as in Example 6 except that the film was stretched 1×4 (MD×TD).

### EXAMPLE 10

The same procedure was used as in Example 1 except that the sample was heated to 125° C. and stretched to a target of 4.5×1.5 (MD×TD) at 400%/sec,, after which it was annealed for 15 seconds at 125° C. before cooling and removing the sample. Four test samples were cut from the film and were tested for shrinkage by soaking the specimens for 30 min at 80° C. and 30 min at 95° C.

### EXAMPLE 11

The same procedure was used as in Example 10 except that the sample was annealed for 30 seconds at 180° C. before cooling and removing the sample. The shrinkage testing procedure was the same as for Example 10.

### COMPARATIVE EXAMPLE C1

A sample of ETFE film (Fluon® 100NJ) of 100 μm thickness was obtained from AGC Chemicals Europe (Amsterdam, The Netherlands),The sample was then tested for Haze according to the method of Example 1.

### COMPARATIVE EXAMPLE C2

A sample of ETFE film (Nowoflon® ET6235Z) of 100 μm thickness was obtained from Nowofol Kunststoffprodukte GmbH & Co. KG (Siegsdorf, Germany). The sample was then tested for Haze according to the method described below.

### COMPARATIVE EXAMPLE C3

A sample of ETFE film of 200 μm thickness (Fluon® 200INJ) was obtained from AGC Chemicals Europe. The sample was then tested for Haze according to the method described below.

### COMPARATIVE EXAMPLE C4

A sample of ETFE film of 250 μm thickness was obtained from Dyneon GmbH (the film was made from Dynecn/3M ETFE resin ET6235GZ). The sample was then tested for Haze according to the method described below.

### COMPARATIVE EXAMPLE C5

A sample of ETFE film of 500 μm thickness (Fluon® 500N3) was obtained from AGC Chemicals Europe. The sample was then tested for Haze according to the method described below. It should be noted that, while Table 1 states that the initial thickness of the sample is 515 μm, the variation i n sample thickness is ±5%, and therefore, it is not inappropriate to refer to the sample has having a nominal 500 μm thickness.

### COMPARATIVE EXAMPLE C6

A sample of the same ETFE as used in Comparative Example C5 was stretched by the procedures set forth in Examples 1-3 above except that the film had a target stretching ratio of 1.5×1.5 (MD×TD).

### COMPARATIVE EXAMPLE C7

A sample of the ETFE used in Comparative Example C5 was stretched by the same procedures as in Example 3 above except that the film had a target stretching ratio of 2.5×1 (MD×TD).

### COMPARATIVE EXAMPLE C8

A sample of 300 μm thick ETFE from Nowofol (Nowoflon® ET 6235 Z) was processed by the same procedure as in Comparative Example C6.

From Table 1, it is seen that the only ETFE films that have a Haze lower than 2% and at the same time are thicker than 150 μm are those that have an Ax >1.65 and have a starting thickness of >500 μm. The crystallinity of these film samples is not expected to be significantly different to that of the starting films since the stretching occurs significantly below the melting temperature of the ETFE (260° C.-275° C.).

The impact of Area Stretch Factor Ax on Haze when stretching a 500 micron film is shown graphically on FIG. 4. FIG. 4 shows the calculated film area stretch factor (Ax) plotted against Haze (%) for the film samples referenced in the legend on the figure and processed under the stated temperature conditions. What is apparent from this figure is that the higher temperature produces the best results and that having an area stretch factor [Ax] of at least 1.65 ensures that the haze will be <2% . It does not matter whether the stretching is biaxial or uniaxial provided the area stretch factor is >1.65.

One of the consequences of stretching films is that shrinkage can occur when the film is heated in use. This shrinkage is sometimes desirable (e.g., heat shrink films), but in many cases it can detract from the long term stability of the film. We have taken some stretched films and annealed them at different temperatures and for different lengths of time, as explained in Examples 10 and 11 above. The samples were then subjected to various heating conditions and tested for shrinkage. The results are shown in Table 2 which demonstrates that shrinkage of these films can be practically eliminated with appropriate annealing conditions, which in this specific embodiment, is 180° C for 30 seconds.

### See Table 2 in Appendix

The appropriate area stretch factors (Ax) reported herein were all obtained using a bi-axial stretching process which closely resembles a teetering process as used in the industry. However, it should be understood that these values for Ax may also be achieved through other film stretching processes known in the industry without detracting from the spirit of the invention. These processes include, without limitation, sequential stretching, blown film, and similar continuous as well as batch processes.

### (2) Analysis of the Microstructural Modifications in ETFE Specimens Navin Low Haze

The following is a detailed analysis of the microstructural modifications that occur in the film to result in low Haze. Spectroscopic analyses of the films after stretching allow for the specific identification of films that have been processed through the conditions described in this invention.

A) Quantification of Scattering (haze)

The quantification of haze for polymer films is commonly measured using ASTM D1003. See, American Society for Testing and Materials document titled “Standard Test Method for Haze and Luminous Transmittance of Transparent Plastics,” 2000 (ANSI/ASTM D1003-00), Although this method is simple and useful in many cases, it does not take into account the wavelength dependence of the scattered light. In this Section, three methods are used to quantify scattering of light: (I) the standard Haze, according to the ASTM; (II) the Parametric Power Law (PPL) method described by Tsu, et. al., “Quantification of diffuse scattering in glass and polymers by parametric power law analysis of UV to NIR light,” Surface & Coatings Technology, Vol. 336, Pages 39-53 (2018); and (III) a secondary method that uses the net absorptance [A550] at a wavelength of 550 nm.

Method (I) gives a number for the scattering level of visible light, as indicated by the term “Haze”. This is a term universally used by practitioners in various fields of polymers and glasses. It gives one a measure of the scattering, but since it makes use of integrations (over the visible (VIS) band, from 380 to 780 nm), there is no possibility of learning the nature of the scattering mechanism.

To gain access to such dimensional aspects of materials, the conventional method is to use X-ray diffraction (XRD), where for the meso-scale (i.e., a few to a few 10's of nm) determinations, small angle X-ray scattering (SAX) and ultrasmall angle (USAX) is used, as described in an article by Miranda, et al., “Fluoropoiymer microstructure and dynamics: Influence of molecular orientation induced by uniaxial drawing,” Polymer, Vol. 91, Pages 211 (2016). While powerful, these X-ray methods are often not available to researchers, and so we have developed method (II), the PPL analytical method.

The PPL analytical method uses the same tools to measure Haze as does method (I), that is, VIS light and conventional spectrophotometers with integrating sphere detectors. Advantageously, this method provides structural information comparable to the X-ray methods. In PPL, we account for scattering by two basic sizes of the scattering centers: (i) the SMALL centers have a wavelength dependence to the scattering, which is well modeled by a power law dependence; and (ii) the LARGE centers have no wavelength dependence, and so offer a DC-like offset to the scattering signal.

Finally, there are occasions in which the scattering signal [T_{d}] is not available for various reasons, but the specular signals of reflectance and transmittance [R,T] are available, In this case, herein referred to as method (III), the absorptance [A] can be used as a secondary method to quantify the scattering, and thus the Haze. In fact, many researchers in this field have used similar methods, e.g., where they follow the [T] at a certain wavelength, illustratively 300 nm, to get a measure of the scattering. However, Method III, which we have developed, is slightly more sophisticated.

B) Quantification of Scattering (PPL)

In the PPL method, the forward diffuse scattering signal [T₉] is represented by the following equation:

T_{d}=LARGE+SMALL (Eqn. 1)

or more specifically,

T_{d}=Con+A(2π/λ)^{B}=Con+Aω^{B}, (Eqn. 2)

in which the LARGE scattering centers are quantified by the constant “Con” term, and the SMALL centers are quantified by the [A,B] terms. Tsui, et al., supra., showed that the power law ‘B’ uniquely gives the dimension (as the radius) of the SMALL centers. We note that although we use the term “radius,” in no way do we imply that the SMALL centers are in fact spherical. Instead, it should be understood that such radius represents an effective size. The ‘A’ term is an amplitude-like term that depends on both the scattering efficiency and the number density. However, once ‘B’ is measured, this determines the radius (a) and so knowing ‘a’ gives the scattering efficiency. Thus, ‘A’ ultimately yields the number and number density of SMALL scattering centers,

By Eqn, (2), it is evident that the power law is vs, the wavenumber (ω) and not the wavelength (λ). We stress that the measured [T_{d}] signal is fit and so the [Con,A,B] values that result from this procedure are to be considered measured quantities, In short, the PPL method takes these [A,B] values and obtains the radius and density [a,Nₐ] of the SMALL centers, We note that [T_{d}] is not the raw forward scattered signal, but is corrected by the residual [T0] signal (integrating spheres always have a residual signal even though no sample is present), as well as corrected for the base absorption within the material as given by a normalization to [1−(R+T)]. This normalization correction means that we have satisfied conservation of energy.

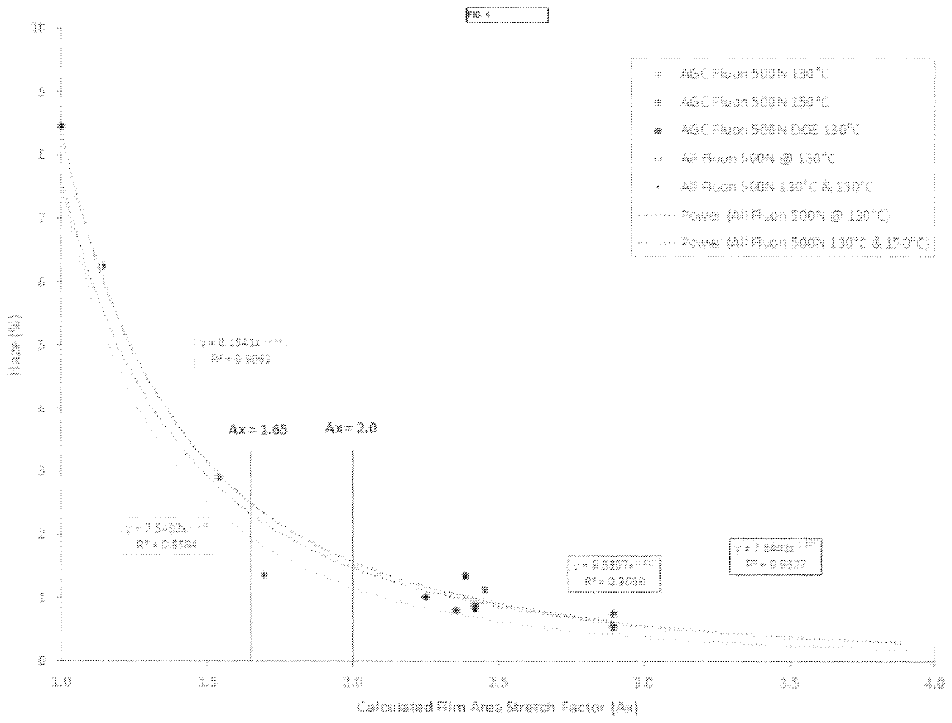

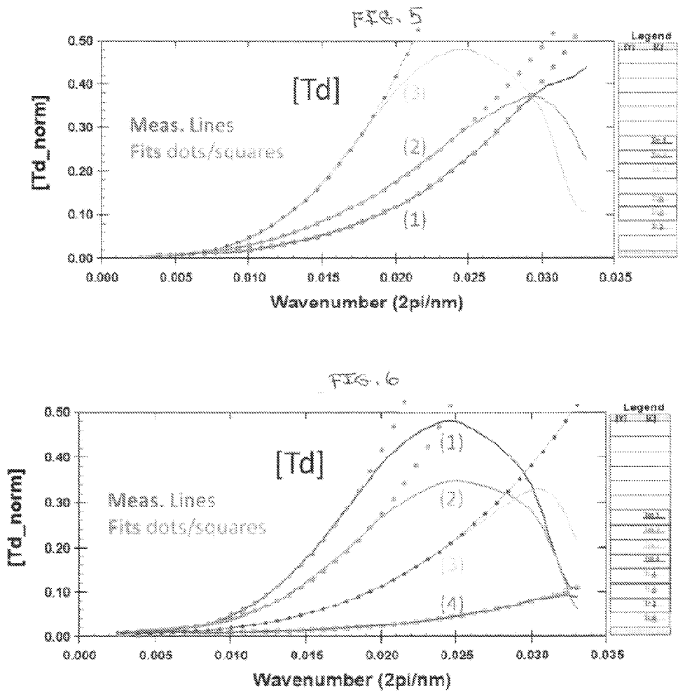

FIG. 5 shows an example of the normalized [T_{d}] signals from unprocessed ETFE having various sample thicknesses. Here, we show the [T_{d}] data as well as the fits (dots and squares). In this example, the thinner samples clearly have lower scattering compared to the thicker samples. Method II enables us to determine what the native scattering is that is independent of the thickness. In comparison, FIG. 6 shows the [T_{d}] signals of processed ETFE samples which were stretched at 130° C., all beginning with a sample thickness of 500 μm (upstretched), and ending at thinner dimensions. Even though the specimen labeled (4) in this figure is nominally the same thickness (210 μm) as specimen (2) in FIG. 5 (205 μm), it is clear that the stretched sample has significantly lower scatter, and thus lower Haze.

Table 3 summarizes the PPL processing of the [T_{d}] data. Note that the “Haze” column gives the conventional Haze values. The “Combined” column gives the results of Eqn. (2) in terms of the LARGE plus SMALL components, Here, a wavelength of 550 nm (being in the center of the photopic human eye sensitivity) was used in the computed “Combined” signal.

### See Table 3 in Appendix

FIG. 7 shows that the PPL Combined signal is in nearly perfect agreement with the conventionally obtained Haze values (correlation, R²=0.9993), The slope is slightly less than 1.00 as a result of subtle differences in how Haze handles human vision (by use of a simple integration without actually weighting by use of the photopic response of the eye), Nevertheless, the near-perfect correlation indicates that the PPL can well represent all the information given by the Haze value, There is, however, a significant difference. With conventional haze measurement, the Haze value is the only information that is obtained, In contrast, PPL provides a substantial amount of detail into how the scattering structure factor is actually changing as a result of processing of the material, As used herein, when we report haze, it will be the Haze values that researchers are accustomed to.

The first powerful advantage of the PPL analysis is that the scattering can be dissected into the LARGE and SMALL contributions as shown in Table 3 above. Table 3 also shows these signals as a percent of the total Combined signal. For the untreated samples (Set-A0), the SMALL contribution to the total scattering amounts to between 70 and 100%. Then, as the material is processed by stretching, the major contribution to total scattering begins to shift away from the SMALL centers toward the LARGE centers. This surely indicates structural changes within the material. These changes to the LARGE and SMALL contributors are shown graphically in FIG. 8, Here, the contribution by these SMALL centers reduces in quite linear fashion as the thickness of the sample decreases, with the contribution by the LARGE centers growing correspondingly.

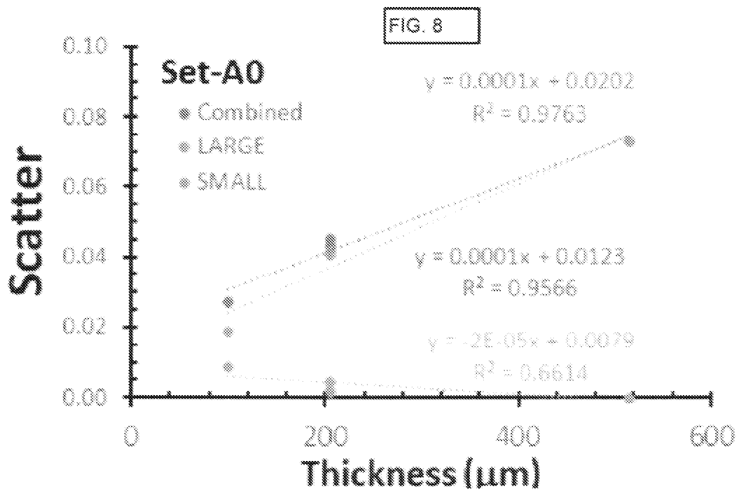

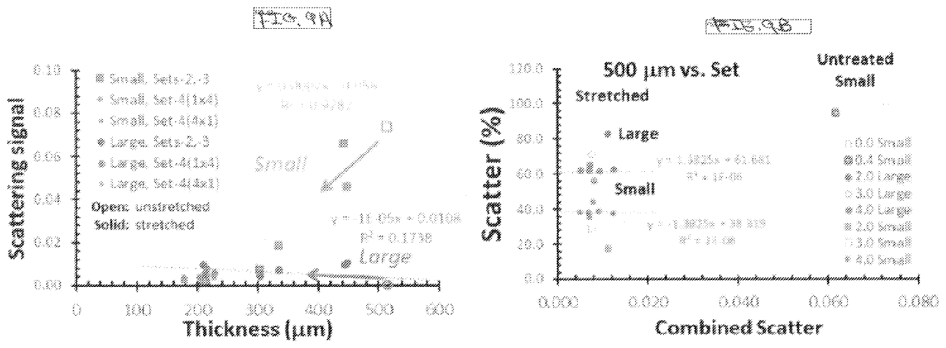

As the material is processed by stretching, FIG. 9A and FIG. 9B show how these LARGE and SMALL scattering signals change with processing (FIG. 9A) and as percent of total scattering (FIG. 9B). The SMALL signals strongly fall as the material becomes thinner, while the LARGE signal slowly increases. Ultimately, the LARGE centers dominate the total scattering, at about 60% of the total scattering signal for the stretched materials.

PPL enables the scattering signal to be decomposed into the [LARGE, SMALL] components, Referring to FIG. 9B, the untreated scattering state was composed almost entirely of SMALL centers. With the stretch treatment of the present invention, the SMALL scattering was reduced and the LARGE scattering enhanced so that eventually, the LARGE centers dominate the scattering for the most stretched material. This analysis strongly suggests that there is an agglomeration process occurring, i.e., the SMALL centers are consumed by and/or converted into LARGE centers.

A second powerful advantage of the PPL analysis is that the SMALL scattering centers can be quantified in detail. Table 4 shows the radius of the SMALL scattering centers, as well as their density. Here, we find radii on the order of 20 to 40 nm for the untreated material (Data Set-A0). These values are in fine agreement with dimensions determined by the SAX and USAX analyses by Miranda, et. al., supra, for ETFE in the unprocessed state. We can now use this information to help us understand more details about the changes. For the LARGE scattering centers, we use a radius of 2000 nm, Since there is no wavelength dependence for LARGE centers (i.e., by definition, B=0 for these), a reasonable estimate as to their dimension can be assigned to them. We have performed a number of calculations using the methods described by Tsu, et al,, supra,, where we vary the dimension of the scattering center in the Mie scattering regime of larger scattering centers to discover how large these centers must be in order for its power law to approach zero, Our calculations show that for radii greater than about 1.5 μm (1500 nm), the power law tends toward zero (B−0), so our use of 2.0 μm is near the minimal size where B will be zero. Certainly, LARGE scattering centers can be >> than 1.5 μm. It must be stressed however, that the ‘Con’ value is a measured quantity and by itself, gives us the total of all the LARGE scattering. Now, however, by this educated guess, we can get a first order approximation as to the density of these LARGE scattering centers.

There is one aspect of scattering that must be understood: when we measure the scattering, there is no a priori way to ascertain whether the scattering derives from within the bulk, or is solely from surface imperfections, This is especially difficult for the thin samples under our examination, Here however, we show in Table 4, in the columns to the right of the SMALL radius, our calculations that assume that all the scattering centers are in the material's bulk for both the SMALL and LARGE calculations.

### See Table 4 in Appendix

While we routinely also examine the calculations under the surface scattering, it became clear by all our analyses that we are witnessing true bulk scattering. So such surface scattering information is not shown here. Thus, Table 4 shows the volume per scattering center for both [LARGE, SMALL] given the [assumed, measured, respectively] radii with the further assumption of sphericity. Since we know their number density, we can also compute the total volume of these scattering centers as compared to the bulk volume. With respect to surface scattering, there are occasions in which the number and size of the scattering centers are so large, that if they were indeed on the surface, their total area would enormously overpopulate the surface. This is a good indication that they cannot be surface features.

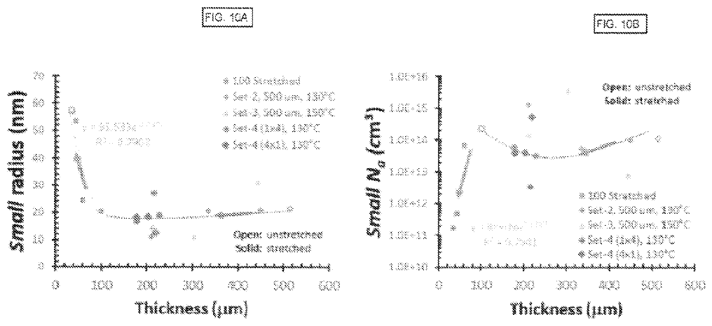

FIG. 10A and FIG. 10B show the radii (FIG. 10A) and number density (FIG. 103) of the SMALL scattering centers as a function of thickness (μm) of ETFE that has been processed under the conditions specified on the figure legend, specifically a 100 um sample; a 500 μm sample stretched at 130° C. (Set-2); a 500 μm sample stretched at 130° C. (Set-3); a 500 μm sample stretched 1×4 (MD×TD) at 130° C. (Set-4); and a 500 μm sample stretched 4×1 (MD×TD) at 130° C. (Set-4).

When we plot the radii vs. sample thickness as shown in FIG. 10A and FIG. 10B important trends emerge. Starting with the 100 μm sample, FIG. 10A shows that its SMALL radii is about 20 nm. Then, as the sample is thinned by stretching, its radii grow to nearly 60 nm. With such exponential growth, one may expect that the scattering should increase, since the scattering efficiency increases with radius. However, as FIG. 10B shows, the number density falls exponentially . . . by three orders of magnitude! It is therefore this strong decrease in number that ultimately leads to a strong reduction in the scattering.

Starting with the 500 μm thick ETFE material, the changes to the SMALL radii are more mild, decreasing from slightly greater than 20 nm, to slightly smaller than 20 nm. However, their number density decreases by about a factor of 10×. So this appears to be what leads to a lower scattering. One way to show this in greater clarity is by computing the total scattering cross-section by all these SMALL centers. We know their radii, and their number densities, so we can therefore combine them to compute the total area by which all these centers scatter light. We will note that since these SMALL centers are in the bulk, the computed total scattering area may in fact be much greater than the total surface area (Aₒ). We will indeed demonstrate this below.

As just stated, we now know two important quantities: (i) the radii, and (ii) the number density. These allow us to compute the total area of all the SMALL scattering centers (A_{Sm}), which we normalize by the sample's physical surface area (Aₒ), i.e., with

(A_{Sm})=πa²×Nₐ×t (Eqn. 3)

in terms of the density and slab thickness (t), then the ratio

R_{Sm}=A_{Sm}/Aₒ (Eqn. 4a)

is a dimensionless quantity. This ratio can be >1.0 because the area of all these SMALL centers throughout the bulk add up to an area greater than the sample's surface area. Note that this ratio is greater for thicker samples as indicated by Eqn. (3). For the LARGE centers, the equivalent ratio is

R_{Lr}=A_{L}/Aₒ (Eqn. 4b)

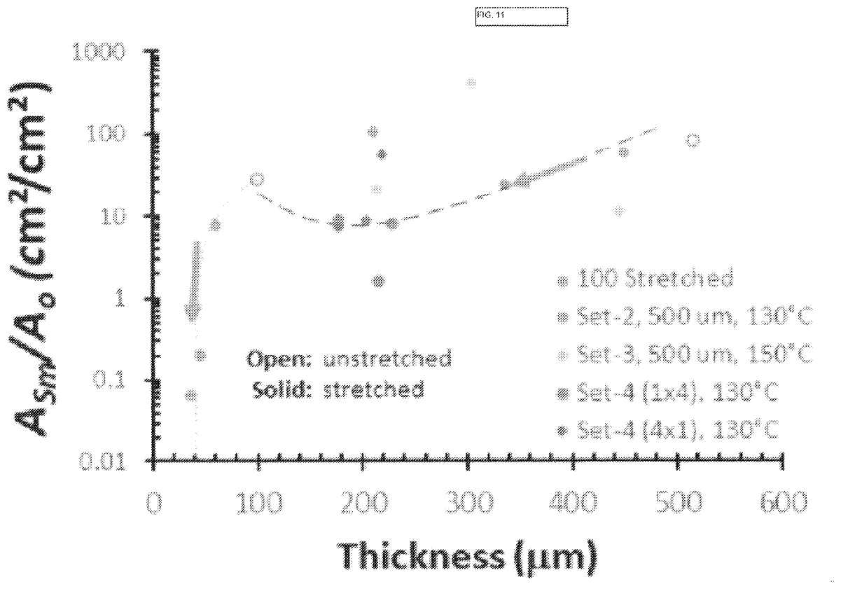

The result of applying Eqn. (4a) to our data is shown in FIG. 11 which indicates that for the 500 μm thick starting material, stretching down to 10 mil (about 250 μm) thickness results in low scattering.

One comment regarding the stretch direction needs to be stressed. We investigated stretching in the “machine direction” (MD) and in the “transverse direction” (TD), where we report (MD×TD)=(1×4) or (4×1) (Set-4). Our data does not show convincingly that post stretching along these different directions makes any distinct difference. In other words, the act of post-processing leads to modifications of the microstructure that overpowers any features that may have been imparted during the film extrusion process.

To summarize, the PPL method reported herein takes advantage of the measured shape of the scattering signal vs. wavenumber, and thereby acquires:

the measured fit [Con, A, B] quantities, then from [A,B], we can derive [a,Nₐ]. From [a,Nₐ] we can demonstrate that specific structural changes have occurred in the effective size and density of the scattering centers due to the stretch processing.

C) Quantification of Scattering by Absorptance

Instead of reporting the Haze quantities, many researchers (see, for example, US Pubn. No, 2002-086963) report how much the “specular” transmittance [T] signal drops at a certain wavelength (e.g., at 300 nm), In the VIS spectral range, the changes in the [T] signal should fall very slightly from the red to the blue wavelengths due to normal optical dispersion. Such dispersion ultimately relates to the optical band transitions in the ultraviolet (UV) spectral region. In the VIS, and indeed far in the NIR region, the ETFE material has no significant absorptions, save the overtone vibrational features which we will discuss in the following section. Clearly, the reason that the [T] falls below what normal dispersion can account for relates to the diffuse scattering of light.

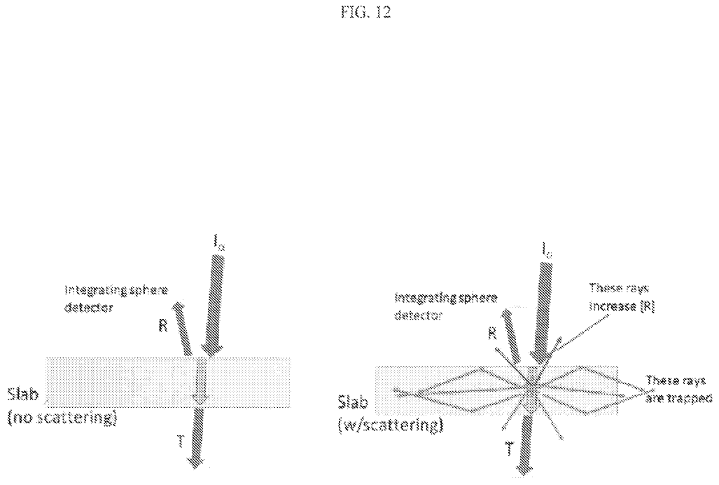

FIG. 12 is a schematic representation of light impinging on a slab of polymer which can be used to show the mechanism that explains why the [T] signal drops with scattering. Referring to FIG. 12A (left side), a reference sample (slab 120) has little or no scattering. In this case, the integrating sphere 121measures the reflectance [R] and the transmittance [T], which themselves derive from the basic Fresnel coefficients at each air/slab boundary, The slab's refractive index [ηₛ] offers a different “optical impedance” from the air's index [ηₒ], so there are the usual Fresnel processes. In contrast, FIG. 12B (right side) shows the case when the slab 120 has scattering centers within its bulk. Although some of these scattered rays end up traveling in the T- and R-directions, many of the rays (e.g., rays 122) travel sideways, where internal reflection keeps them in the slab (until they exit out the ends of the slab). Because of this internal reflection, these rays are not counted by the integrating sphere detector. Thus the usual [T] signal is less than expected. At the same time, those rays (e.g., rays 123) which return back along the same R-direction, add their signals in addition to the reference [R] signal that had only to do with the Fresnel interaction at the slab's external surfaces. Thus, the measured [R] signal increases with scattering.

FIG. 12A and FIG. 12B makes it clear that one way to measure scattering is to sum the usual [R,T] signals, and compare this to the expected 100% that should be the case when there is no true absorption within the slab. In other words, we need to examine the absorptance [A], where since

1=A+R+T (Eqn. 5a)

then

A=1−®+T) (Eqn. 5b)

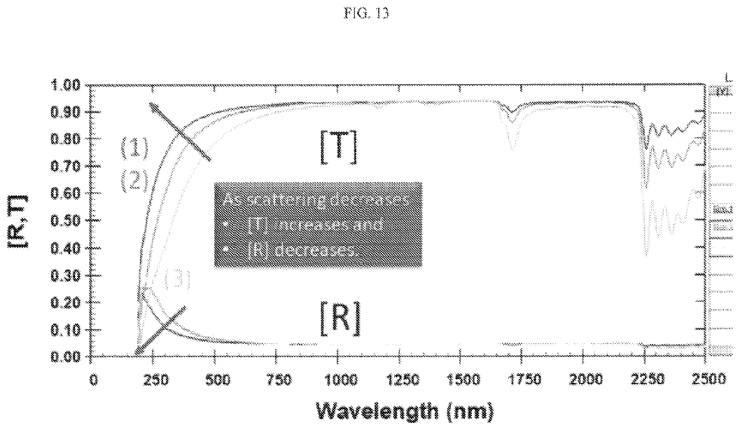

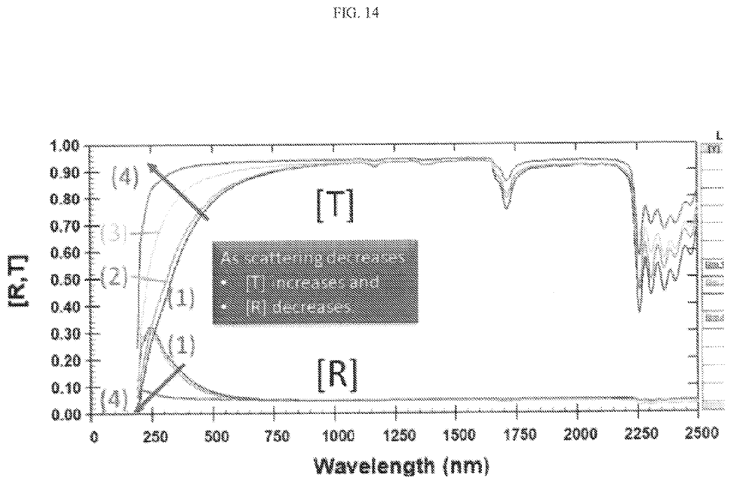

This effect is demonstrated in FIG. 13 using the [R,T] spectra from the same unstretched samples (Set-A0) whose scatter plots were shown previously in FIG. 5. For the thinner slabs, the optical edge in the UV as shown by the [T] data becomes more “sharply defined”, i.e., with less of a gradual sloping character. Also, the [R] data flattens out, trending toward the expected gradual increase for shorter wavelengths due to normal dispersion. In FIG. 13, the narrow dips in the [T] data for wavelengths longer than about 1500 nm relate to the vibrational overtone and combination bands to be discussed below. With stretching, as shown in FIG. 14, the [R,T] signals show an even more impressive trend to “flatten out” compared to simply making the slabs thinner as in FIG. 13.

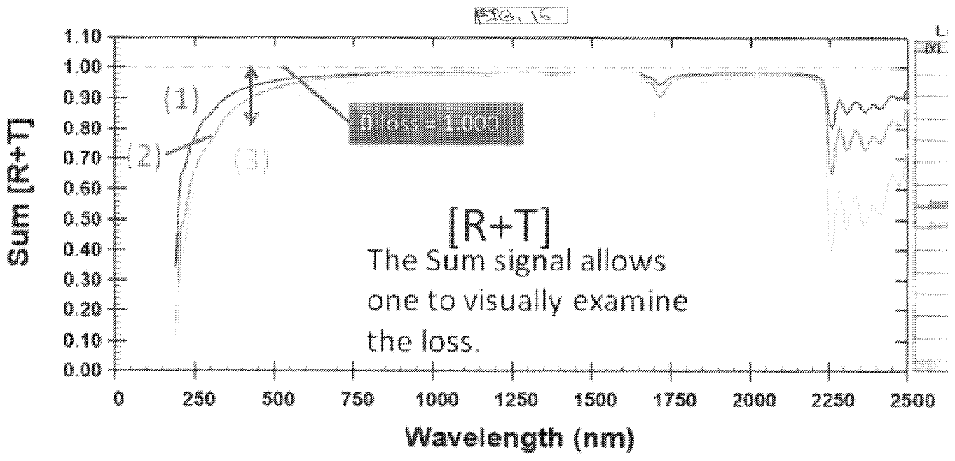

Rather than examining the individual [R] and [T] signals, the sum [R+T] signal, is plotted on FIG. 15 for the unstretched ETFE samples (Set-A0) as a function of wavelength (nm), Clearly, the higher this sum signal is to 1.000, the lower the loss is to the scattering mechanism. The sum signal allows one to visually examine the loss (e.g., arrow 150).

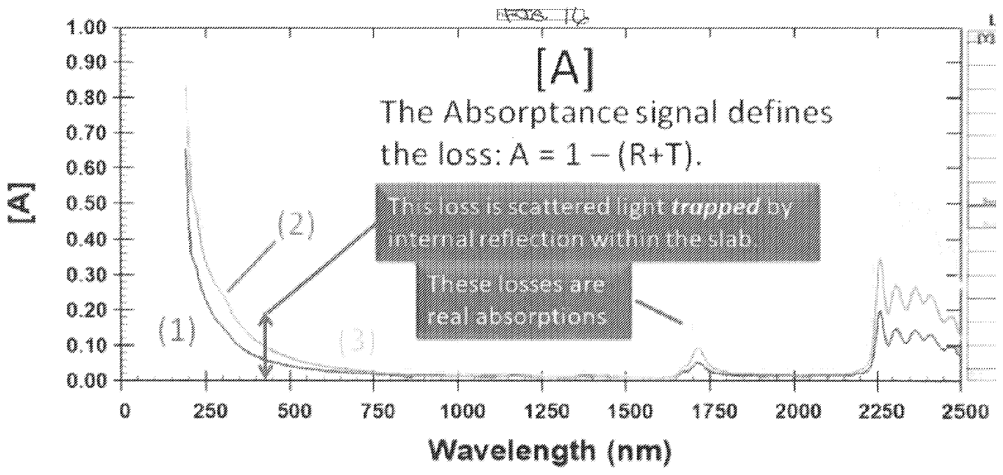

As shown by Eqn.(5), equivalent to showing this sum signal, the absorptance [A] signal can be used to define the loss. FIG. 16 shows [A] plotted as a function of wavelength (nm) for the same unstretched ETFE samples (Set-A0) as in FIG. 15. The loss, as shown by arrow 161, is scattered light trapped by internal reflection within the slab. The losses shown by peaks 162 at about 1750 nm are real absorptions.

Finally, for the purpose of quantifying this scattering, we select a reference wavelength and simply record the A(λ_{ref}) value. For this, we elect to use the peak of the photopic response of human vision, i.e., a wavelength of 550 nm, Since we have independently made actual Haze measurements, we can relate these absorptance scattering values to true Haze values, whose results are shown on FIG. 17. FIG. 17 shows a very high linear correlation ®²=0.94; y=0.7291) to Haze, and its intercept is very near the origin, which we should expect if this [A₅₅] is a good measure of Haze and scattering loss. Therefore, since we expect that the intercept should in fact be the origin, and since our measured data supports this to a very high degree, we will simply set the intercept to the origin, and so

Haze=0.729×[A₅₅₀] Eqn. (6)

C) Quantification of Molecular Structure by NIR

General Overview

FIGS. 13-16 show that there are narrow absorption features in the NIR spectral region, which we have indicated are due to “overtone” and “combination” (herein referred to as the “O/C”) bands of vibrational modes. In this section we demonstrate that the O/C vibrational bands are of importance as relates to intermediate range order (IRO) of the polymer molecules. There are distinct differences in these O/C bands especially when the untreated samples are compared to the stretched ETFE samples. This means that, in addition to the meso-scale changes that we quantified by the PPL analysis, there are also distinct changes to the structure that occurs on the molecular scale. Ultimately, we believe that the meso-scale (as revealed by the scattering in the VIS) and molecular-scale (as revealed by the IR and NIR) changes in structure are both signs, and therefore signatures of the structural changes, that we produce by our treatment process as described in this invention, In other words, one cannot have one without the other.

To begin, molecular vibrations can be observed as absorptions in the infrared (IR) spectral band for wavelengths on the order of 3 μm and longer, In the profession of IR spectroscopy, it is more typical to use wavenumber units (as 1/λ, in cm⁻¹) since wavenumber is linear in energy. Also, we use the word “frequency” since we are describing molecules that vibrate at the same frequency as the IR light. Therefore, most of these vibrational absorption features appear between a frequency of 4000 and 200 wavenumbers (or 2.5 to 50 μm), These are the “fundamental” vibrations, corresponding to transitions from the ground state to the first excited level (i.e., from the 0 to 1^{st} quantum level). These absorption bands also strongly relate to the near-neighbor (NN) environment, and less strongly to the next-nearest-neighbor (NNN) environment. Tsu, et al., supra., have shown that the electronegativity of the groups in the NNN environment can cause measurable shifts in the fundamental frequency. In most cases however, it is quite challenging to determine what the NNN environment actually is, and how this affects the measured IR signal.

As a case in point, suppose that we have two molecular groups, R and (CH,), and these groups are bonded according to (i) R—(CH₂)—R, and (ii) R—(CH₂)₁₀—R. It turns out that while it is easy to identify the presence of R and (CH₂) in both scenarios, it is quite a bit more challenging to discern case (i) from case (ii), i.e., in telling how many (CH₂) groups are linked together. In case (i), the electronegativity of the radical-R can easily influence the C-H₂ stretching vibrational frequency, so if R is a highly electronegative carbonyl (═C═O), this can push the C—H₂ stretching frequency from about 3900 cm⁻¹ to above 3000 cm ⁻¹. Clearly, the NN environment of R—(CH₂)₁₀ has measurable effects. But in case (ii) somewhere in the middle of the long (CH₂)₁₀ chain, it is very difficult to discern the 3^{rd}(CH₂) from the 8^{th} (CH₂) group.

Most of the limitations to understanding the NN and NNN environments strongly pertain to the fundamental vibrations. But there may be opportunity in the O/C spectral region to begin to resolve how NN and NNN molecular groups interact between one another. For this, we take advantage of “anharmonicity.” See, Kazuo Nakamoto, Infrared and Raman Spectra of inorganic and coordination compounds, 3^{rd} Edition, p. 11 (Wiley & Sons, New York, 1978). in the usual simplification that physics takes when analyzing complex systems, the potential well that the atoms within molecules find themselves in, we make a reasonable first approximation that the shape of this potential is quadratic, i.e., V®˜ar². This is referred to as the harmonic oscillator solution, and leads to a selection rule that transitions between quantum states is Δn =±1. So the transition can go from 0-1, or from 1-0, which describes absorption and emission by the fundamental modes, respectively.

The point is that if this selection rule were firm, then we would never be able to observe the O/C features. So the fact that we can indeed observe these features indicates that the original assumption (that the potential is quadratic) was wrong. It has been shown that if higher order terms are included in the potential, i.e., V®˜ar²+br³+ . . . , the selection rule limiting Δn=±1 disappears entirely. This inclusion of the higher order terms in the potential well is called anharmonicity, and our measure of the narrow features in the NIR is entirely related to the anharmonicity.

Band Assignment

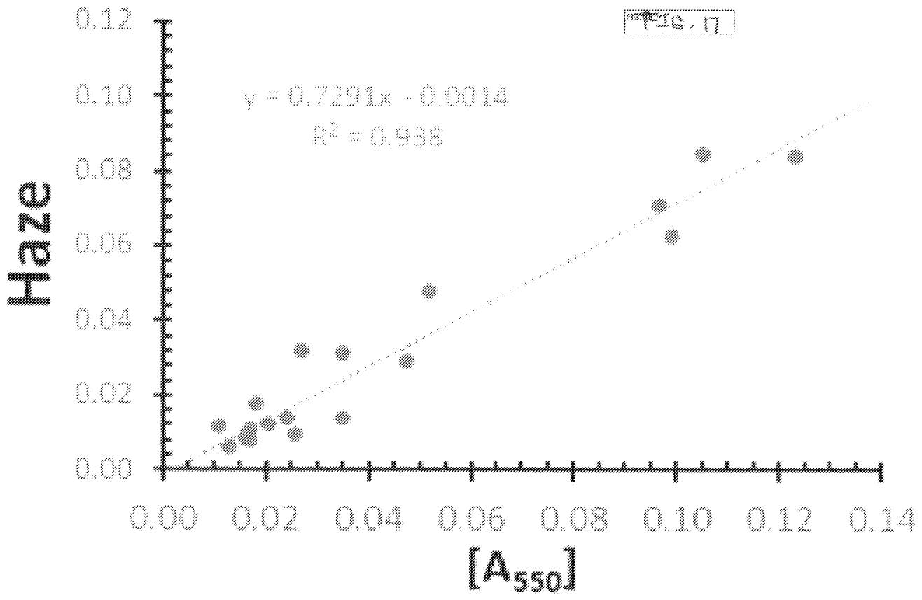

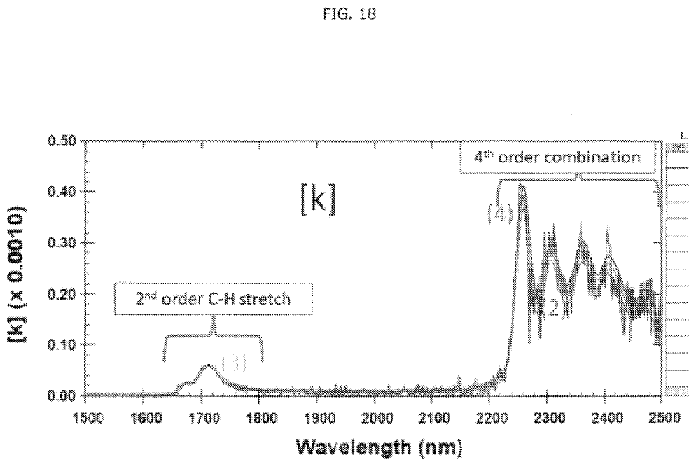

The spectra that we showed in FIGS. 13-16, were taken with a dual-beam UV3600 spectrophotometer by Shimadzu Corporation, Japan, which covers the range from about 190 to 2500 nm, i.e., the UV to the NIR range. In order to understand the nature of these O/C features, we need direct information taken from true IR spectra as obtained from measurements using FTIR spectrometers, Since the FTIR covers a spectral range from 400 to 6000 cm⁻¹, there is significant overlap between the different spectrometers. The absorption spectra for untreated ETFE made by a number of different producers are shown in FIG. 18. Here, the features near 1700 nm relate to the 2^{nd} order C-H stretch vibration (i,e., its 1^{st}) and the complex Set-of-5 bands above 2200 nm are 4^{th} order combination bands. Note that the spectrum for the DuPont sample was taken using an older Perkin Elmer Lambda 900 instrument, and thus, has a higher noise level compared to the data taken by the newer Shimadzu UV3600 instrument. FIG. 18 demonstrates that ETFE produced by four different vendors, have almost exactly the same NIR signatures.

FIG. 19 shows an overlap of the NIR absorption data with those of ETFE and FEP in the IR spectral region. The advantage of comparing with FEP is that this material has no CH content. This therefore allows us to more confidently make the band assignments. For the FEP in the fundamental IR region, there are various C-F₂ bending modes as well as the strong doublet that represent C-F, symmetric and asymmetric stretching modes around 1200 cm⁻¹. We can easily identify the 1^{st} through 3^{rd} overtones of the stretching modes, near 2400, 3600, and 4800 cm⁻¹.

Above the 3^{rd} overtone band of FEP, the ETFE spectra show a modestly strong absorption feature near 5800 cm⁻¹. This is clearly the 2^{nd} order (or 1^{st} overtone) vibration of the fundamental C—H₂ stretching bands seen near 2900 cm⁻¹. Here, we see a doublet at 2880 and 2976 cm⁻¹, representing the symmetric and asymmetric stretching modes of the C—H bonds within the C—H₂ group, respectively.

Between the FEP 2^{nd} and 3^{rd} overtone bands, we observe the complex set of the 5 combination bands of ETFE. These features are well measured by both the UV-NIR and by the IR spectrometers, and their data show substantial agreement. It is abundantly clear that there are no fundamental vibrations of ETFE that when multiplied by simple integers give rise to bands in this NIR region between about 4000 and 4500 cm⁻¹. It is for this reason that these features cannot be related to simple overtones, and must therefore be related to vibrations of the C—H₂ group that couple to vibrations of the C—F₂ group. We refer to them as “combination” bands, because they combine energy between these two molecular groups.

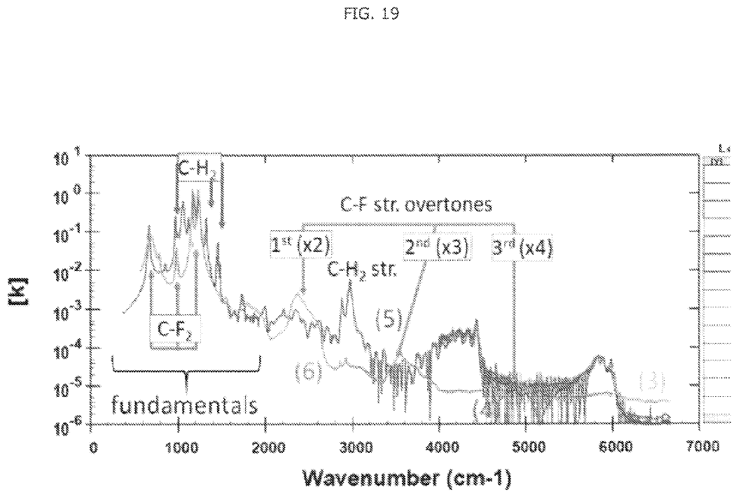

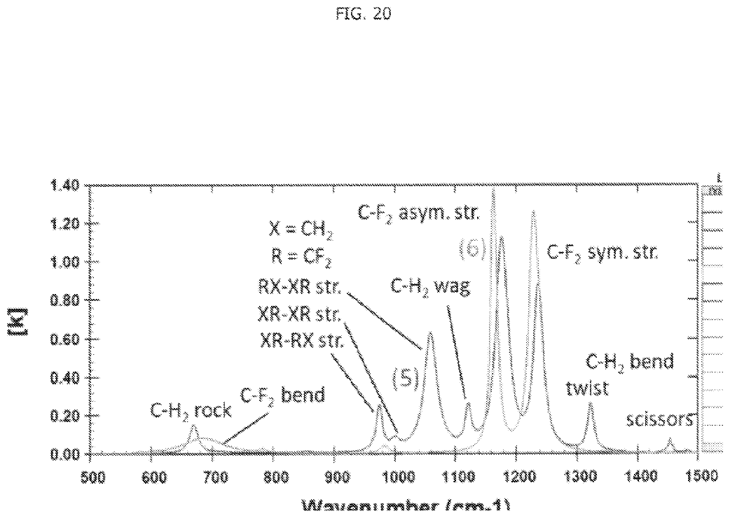

Expanding the fundamental region, and with some help by Silverstein, et al., Spectrometric Identification of Organic Compounds 7^{th} Ed., Page 74, (Wiley & Sons, 2005), FIG. 20 shows our assignment of the fundamental absorption modes, With these modes and their frequencies now determined, they are used to predict how they might be combined to determine the frequencies of the NIR bands. Table 5 summarizes these assignments, In this process, we did not use pure integers to multiply the fundamental frequencies. For example, rather than use 2, we used 1.969, and rather than 4, we used 3.956. In fact, due to anharmonicity, it is expected that the overtone frequencies will be slightly lower than predicted by simple integer assignments. To find these non-integer values, we used Excel's Solver to minimize the error between predicted and measured frequencies.

See Table 5 in Appendix

As expected, the features near 5800 cm⁻¹ are simple multiplicative factors of the C—H₂ stretching vibrations, i.e., these are pure overtones. Also as expected, for the complex Set-of-5, there are no fundamental vibrational frequencies that have muitiplicative factors that even remotely predict their frequencies. To understand these bands, we are obligated to examine combinations between the C—H₂ and C—F₂ vibrations, The band that has the lowest error between prediction and measurement is the 4427 cm⁻¹ band (at 2259 nm), whose error is essentially zero. This band is the 4^{th} order combination of modes 4 and 6, representing respectively, the C—C stretching between the RX—XR groups and the asymmetric stretching mode of the C—F₂ group: here, X=(CH₂) and R=(CF₂).

The most uncertain assignment is the 4238 cm⁻¹ band (at 2360 nm) that has a predicted frequency of 4207 cm−1 for an error of 30 cm⁻¹. The most complex combination of bands appears to be the 4336 cm⁻¹ (at 2306 nm), which may be due to combinations of modes (4 and 5) plus those of (2 and 7).

The bottom line is that we have been able to predict the combination frequencies from known fundamental frequencies with errors that are on the order of only 10 cm⁻¹ and lower, Thus, when we show how processing the ETFE will change the intensities of various bands within this complex Set-of-5, the coupling between the (CH₂) and the (CF₂) groups are certainly altered in fundamental ways so that the resulting product is unique.

D) Quantifying the Reference Untreated ETFE Material

The importance of the O/C bands cannot be overstated as it pertains to studying IRO interactions between molecular units within the material. The coupling between groups as seen in the fundamental region is difficult to discern. In contrast, the very appearance in the NIR of these features leaves no doubt that these molecular groups are coupled. It, therefore, becomes important to quantify them by band fitting. In this section, we describe the fitting procedure where we first apply this fitting to untreated ETFE material. We will demonstrate that there is strong stability over the untreated samples from various sources. Therefore, the ETFE film can be obtained from any manufacturer and can be treated in accordance with the method of the present invention to result in a final product that has the properties defined by the principles of this invention.

We are particularly interested in the Set-of-5 combination bands seen in the NIR for wavelengths greater than about 2200 nm. We have measured the specular [R,T], and then have numerically solved for the slab's, optical constants, i.e., the refractive index and extinction coefficient given by [n,k] as described by Tsu, “Infrared optical constants of silicon dioxide thin films by measurements of R and T,” J. Vac. Sci., Technol. B, Vol. 18, No. 3, Page 1796 (2000) and Tsu, “Obtaining optical constants of thin GeₓSb_{y}Te_{z} films from measurements of reflection and transmission,” J. Vac. Sci. Technol. A,Vol. 17, No.4, page 1854 (1999).

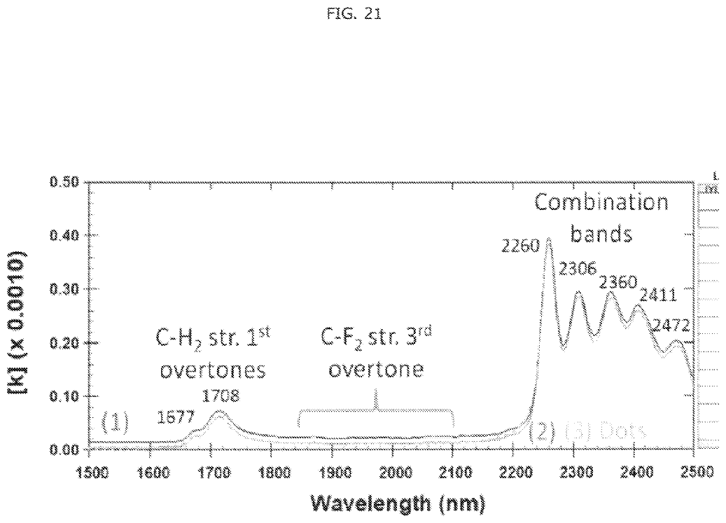

Next, we fit the [k] data by Drude-Lorentz (D-L) oscillator functions as described in John R. Reitz, Frederick J. Milford, Robert W. Christy, Foundations of Electromagnetic Theory, 3^{rd} Edition, (Addison-Wesley, Reading, Mass., 1980), Chap. 19. Technically, we do not fit in [n,k] space but in [\acute{ε}] space, the complex dielectric function. So rather than fit the peak position, ampiitude and width of the [k] data, we fit the restoring force, plasma and damping frequencies [ωₒ, ωₚ, δ]. In short, we first transform [n,k] into [\acute{ε}], then fit, then transform the fit [\acute{ε}_{fit}] back into [n,k]_{fit}. Before we fit, we remove by subtraction a very small residual from [k] as given at a wavelength of 1300 nm. We will use a total 9 D-L terms, five for the Set-of-5 for wavelengths longer than 2200 nm, a 6^{th} D-L band for the “in-between” region between 1800 and 2200 nm, and three more for the C—H₂ 1^{st} overtone near 1700 nm. A typical fit result is shown in FIG. 21 for untreated ETFE by AGC. Although the in-between region shows no distinct shape, or obvious peak, it is likely that, considering the FEP data, it is related to the 3^{rd} overtone of the C—F₂ stretching mode. Nevertheless, we will not follow its amplitude.

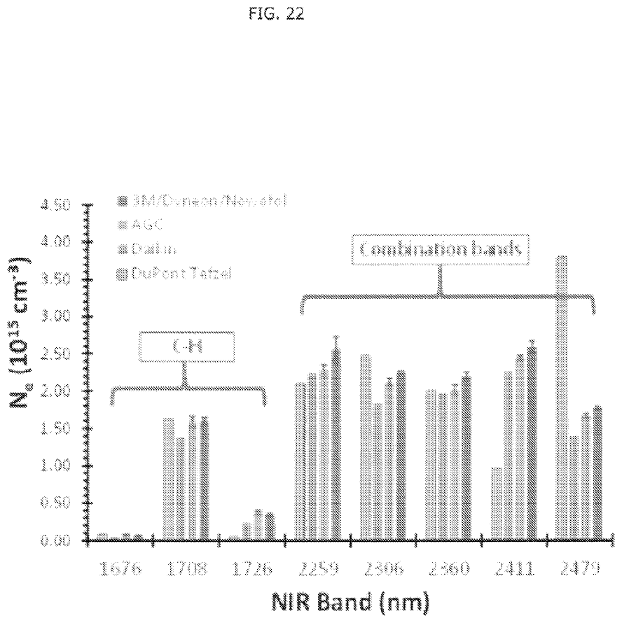

In the following, we follow the “amplitude” of these 8 bands, as given by the charge density (Nₑ) that has been determined by the ωₚ fit parameter. This Nₑ refers to the dipole moment that allows for the interaction between the vibration and the IR light. FIG. 22 summarizes Nₑ for all the untreated ETFE samples under investigation. As indicated previously indicated, we have found substantial similarity in the ETFE product of all vendors. The small error bars for the 3M and AGC samples derive from the use of multiple samples of different thicknesses. The exception to the similarity appears to be the 2411 and 2479 nm bands of the DuPont sample. Note however, that since this was taken with a different spectrometer, which had significantly higher noise in this long wavelength regime, the data here is less reliable. The bands at shorter wavelength (where the S/N is acceptable) appear to be in fine conformity with the bands for material produced by others.

FIG. 23A and FIG. 23B show how the combination bands change with thickness for the 3M/Dyneon and Nowofol (FIG. 23A), and the AGC (FIG. 23B) samples. When we solve for the [n,k] from measured [R,T], the sample thickness is included in the process. This means that if the molecular concentrations are similar, the NIR vibrational bands should be similar as long as the coupling mechanism remains the same. Each of these NIR bands appear to be quite constant with varying thickness, meaning that there appears to be no coupling differences for samples of different thicknesses or made by different producers.

Another way to examine these differences is to focus on the internal relationships between the various individuals of the Set-of-5 bands. Referring to FIG. 24, the amplitude of the 1^{st} member (at 2259 nm) of this group is plotted against the 4^{th} member (at 2411 nm) of the Set-of-5 bands. For the most part, this shows that these bands are tightly grouped together, as indicated by the circle on FIG. 24. For the plot of FIG. 24, we used a fairly large (x,y) axes range, to prepare for comparison to the stretching data that follows in the next sub-section. Since the nature of the coupling between these (1st, 4th) individuals differ as shown above, the fact that these shows tight similarity in this plot demonstrates that the nature of the coupling is quite consistent for these samples of different thickness that were made by different producers. In the next section, we will show that this strongly changes with stretch processing of the material.

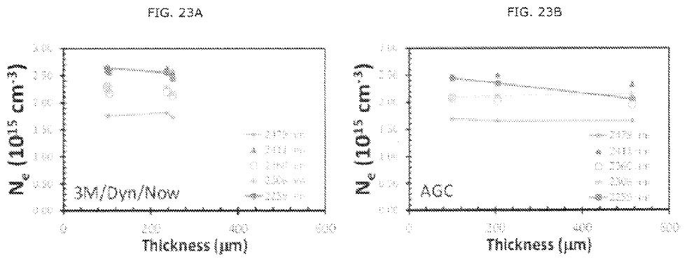

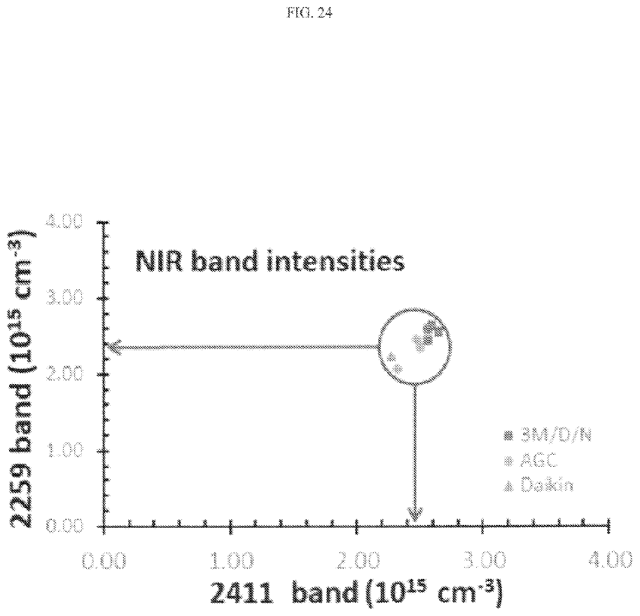

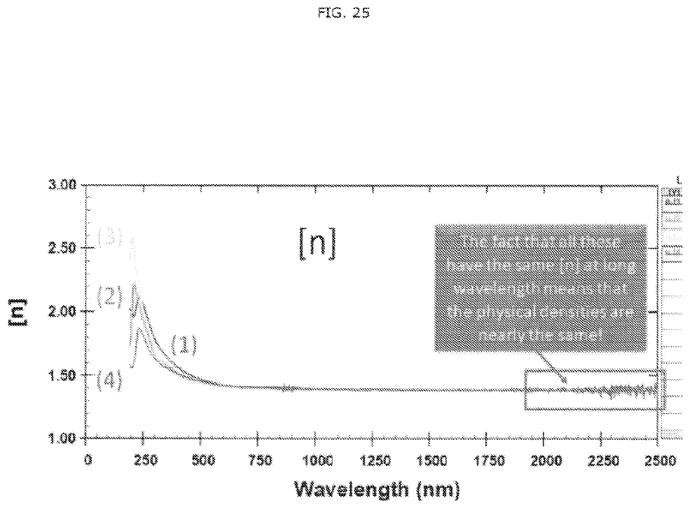

The refractive index in the long-wavelength limit, gives a good indication of physical density of the samples, where the greater the density, the greater the index (as long as the atoms are the same). FIG. 25 shows the measured refractive index [n] for untreated material made by various producers, Analysis of the [n] for all of the untreated samples shows that [n]=1.3827±0.0021 (0.16%). The fact that the refractive index at long wavelengths is the same means that the physical densities of all of the ETFE samples are substantially the same,

Lastly, a side note about the strong rise in [n] on FIG. 25 at the shorter wavelengths, We saw in FIG. 13 and FIG. 14 that samples can have anomalously high increases in reflectance [R] for shorter wavelengths which is caused by greater scattering. Since [R] is strongly connected with the refractive index [n] by the Fresnel coefficients, this then translates to strong increases in [n], as clearly shown on FIG. 25.

E) Quantifying the Treated ETFE Material

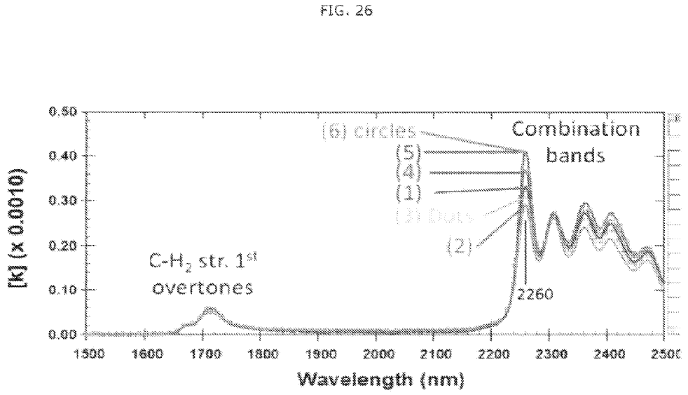

In the previous sub-section, we found that the Set-of-5 combination bands had substantial similarity between samples that were made by the same producer, but with different thicknesses, and for samples made by different producers. We now demonstrate that such similarity is broken with our stretch process, as shown in FIG. 26. Referring to FIG. 26, we show the measured C/O absorption [K] for a 500 μm thick sample of unstretched ETFE made by AGC (line 1) which is then stretched so that the thickness ratio drops (from 1.00 for unstretched) from 0.90 to 0.42. For these examples, we noted substantial differences in this Set-of-5 combination bands that had not been seen in the reference untreated samples. Although the largest difference appears in the 2260 nm band, the other members of the Set-of-5 also experienced some change. In contrast, there appears to be much less change affecting the C—H₂ overtone bands.

One might be tempted to think that these changes in [k] are due to different physical densities. But there are two observations that demonstrate that this is simply not the case that relate to: (i) the long wavelength refractive index; and (ii) to the way [k] changes for each member of the Set-of-5. In (i), for all these processed materials, their index is [n]=1.3782±0.0049 (0.35%). This is slightly lower (by 0.33%) than the unstretched material at 1.3827. If this were the explanation, then all the bands would drop by this amount. But this is so small that it would hardly be measurable. Then in (ii) even if the density were to change by measurable amounts, this would predict that all the members of the Set-of-5 would chance in similar directions and by similar amounts. Instead, FIG. 26 shows that both the directions of change and the amount of change are dissimilar across the members of this set. Thus, the changes that we observe in FIG. 26 are certainly not caused by any change in the physical density. Instead, these changes are consistent with changes to the coupling between the molecular units that make up ETFE.

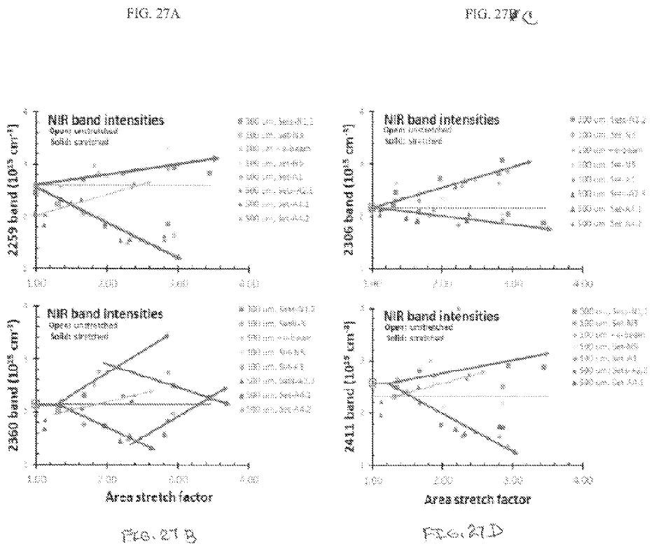

FIG. 27A through 27D are NIR absorption plots of four of the five Set-of-5 NIR band intensities (10¹⁵ cm⁻³) versus the area stretch factor (Ax) of ETFE samples having different starting thicknesses. Although we start at different base thickness values (e.g., at 100, 300 and 500 μm), it appears that when we plot against the thickness ratio, there are three aspects of the changes that are immediately obvious; (i) there appears to be a “quiescent” state where small reductions to the thickness ratios do not lead to measurable changes to the band strengths; (ii) from the untreated state, the change can lead to both positive and negative changes in band intensity; and (iii) the Set-of-5 bands show strong similarities in their response to the stretching that is nearly independent of the starting thickness.

Referring to the figure legends on FIGS. 27A through FIGS. 27B, the starting thickness and processing conditions are identified. For Example, Sets-N1,2 which start at 300 μm, and for all the 100 μm sets, their data points show strong overlapping behavior. For the 500 μm Sets-A2,3, these points appear to be offset by only a small amount. However, for the other samples starting off at 500 μm, like Set-A4.1 (which was stretched along TD) and Set-A4.2 (which was stretched along MD), these points once again align well with the 100 μm and 300 μm values.

The fact that we observe both positive and negative shifts in amplitude for the same area stretch factor [Ax], appears to demonstrate that there are two different IRO environments that we can “lock” onto. In some cases, the band shifts along the “positive branch,” while in other cases (and under identical conditions), the band shifts along the “negative branch.” This switching between these branches appears to be random. It is rare that the bands show no shift in strength with changes in the area stretch factor.

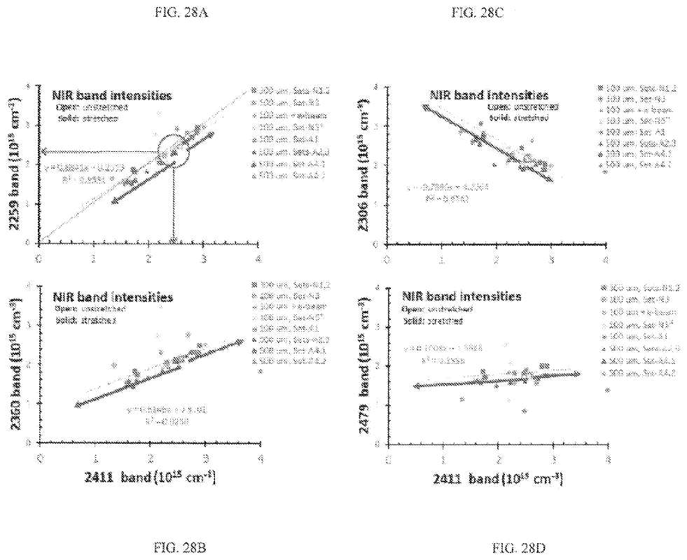

Because these Set-of-5 bands derive from higher quantum levels with complex combinations (i.e., coupling) of the (C—H₂) and (C—F₂) vibrational energies, we should expect that if one member of the set should couple more strongly, then there should be another member of the set that will couple more weakly. We can demonstrate that this is in fact the case. In FIG. 28A to FIG. 28D, we compare the band strengths against one member of the set. This reference member was chosen to be the 2411 nm band. In FIG. 28A (the upper left hand panel of this figure), we see there is a very strong linear correlation ®²=0.959) between the 2259 nm and the 2411 nm reference bands. There is a circle on FIG. 28A showing the locations of the untreated samples as was previously shown in FIG. 24. It is now evident that we selected the (x,y) scales for FIG. 28A through FIG. 28D because the range in intensities upon the stretch processing is quite large.

While the 2259 band grows or shrinks in the same direction as the 2411 nm band, FIG. 28C (the top right panel) shows that when the 2411 band grows, the 2306 nm band shrinks, thus it is opposite to the 2259 nm band. Moreover, the magnitude of their slopes (0.88 and 0.79) are comparable. These observations are a hallmark of coupling, and thus offer further confirmation to the importance of coupling in these Set-of-5 bands.

To summarize, the findings in this subsection:

We have examined the reference untreated material received from different producers and at different thicknesses.

We find that the NIR O/C signatures are quite stable across all these different samples; and

The variation of [n], which is a measure of the physical density, is very small (±0.16%).

We have examined a number of different processing parameters applied to these ETFE samples, including stretching to different Area stretch factors,

There appears to be a very small reduction in the refractive index with stretching (by about 0.33%),

Since [n] is closely related to the physical density, this implies that with stretching, a very small decrease in the physical density occurs.

This however cannot explain the change to the NIR band that we have observed, since the change in the band amplitudes would be too small to measure; and the change in density would create the same change across ail the members of the Set-of-5. We found that with some members, their intensity increases, while with others, their intensity decreases with stretching.

We find significant changes to the NIR combination Set-of-5 bands, whose magnitude of these changes are well beyond the small variations seen in the untreated samples.

These changes in amplitude appear to traverse along two quite distinct paths, where we identify a positive branch whose amplitudes increase with stretching, and a negative branch whose amplitudes decrease with stretching.

Whether the band traverses up the positive or down the negative branch appears to be random.

The fact that there are two distinct branches, means that our stretch process has created two distinct IRO environments that do not exist in the untreated state.

We found additional evidence to support the coupling nature of the band members of the Set-of-5:

(1) the peak position analysis that we performed tells us that these bands cannot be simply overtones of the fundamental (C—H₂) and (C—F₂) vibrations. Instead, the NIR bands must be composed of combinations of these different groups.

(2) in contrast to examining the positions of the members of each band within the Set-of-5, we find that with stretching, there are significant changes in their amplitudes, where in some cases, there are positively correlated changes, while in other cases, there are negatively correlated changes. If the bands are indeed coupled, then we must find both (±) correlations, which in fact we did, otherwise, the “coupling” picture would not be justified.

Scattering vs. NIR

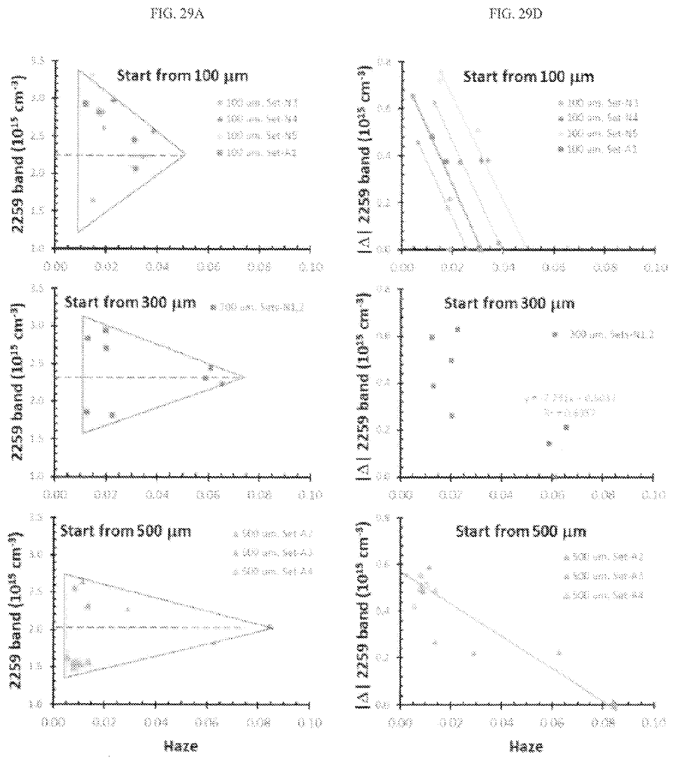

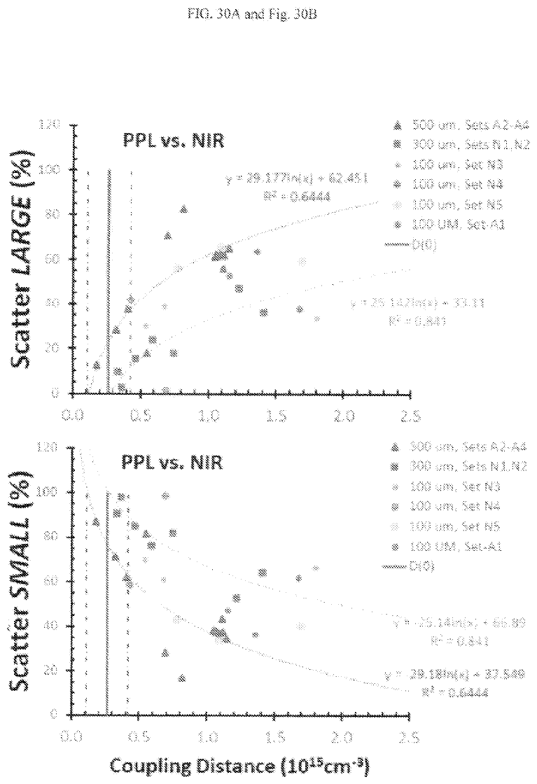

In this section, we examine the connections between the Haze and the NIR Set-of-5. FIG. 29A to FIG. 29F shows how one member of this set, the 2259 nm band, relates to the Haze. On FIGS. 29A through FIG. 29C (the left hand panels), we plot the measured magnitude of the 2259 nm band, and for FIG. 29D through FIG. 29F (the right hand panels), we take the absolute value of the change relative to the unstretched samples. By using the absolute values, we recognize that the positive and negative branches both relate to fundamental changes to the microstructure, and that both of these new structures appear to promote a lowering of the Haze. Here, there is a modestly good correlation ®²=0.64) between the |Δ|2259 levels and Haze. It is of interest that in all these samples, the conditions that show the lowest Haze all have similar |Δ|2259 levels of about 0.6×10¹⁵cm⁻³. This strongly suggests a similarity in the molecular environments that lead to the low Haze condition.

One problem with using the Haze in these plots, is that the thicker samples may have greater Haze even if the intrinsic scattering properties are similar, whereas the |Δ| values are intrinsic by their nature. We can see this effect, especially in FIG. 29A through FIG. 29C, where the thicker the sample, the more the triangles shown in the figures are elongated.

Another problem with Haze, is that the scattering has more than just one internal factor. For example, we found in the PPL analysis, that we were able to reduce this internal complexity of scattering to two main classes having [LARGE, SMALL] centers, and within the SMALL centers, there are its size and number density. These issues explain the difficulty in relating the intrinsic NIR data to the extrinsic Haze data meaning that trying to plot the NIR versus the Haze does not reveal any underlying connection between the two. Clearly, we need to compare the changes in the NIR to a more intrinsic property of the scattering, and for this, we will use the PPL results.

But first, with respect to FIG. 29, we had defined the absolute value of change (|Δ|) based on examining only one member of the Set-of-5, This is equivalent to examining only one dimension of a multi-dimensional object, where there are 4 more dimensions to complete the Set-of-5. In fact, what we are trying to do is to define the vector difference between the Set-of-5 that represents the reference unstretched state (call this vector U), and the stretched state (call this the vector S), so that their difference is

D=S−U (Eqn, 7)

whose magnitude is the distance in multi-dimensional space given by

D_{coupling}=|D|=(Σⱼ^{≡}=₁(Sⱼ−Uⱼ)²)^{1/2} (Eqn. 8)

where the sum is over each of the 5 members of the Set-of-5, This difference then defines the molecular structure that is produced upon our stretch processing of the ETFE material as it relates to the intermediate range order (IRO) of modified coupling. it is therefore the coupling difference between the stretched and unstretched state of the material. It is now clear, that our earlier use of is just one element (j) of the (Sⱼ−Uⱼ)² term in Eqn. (8).

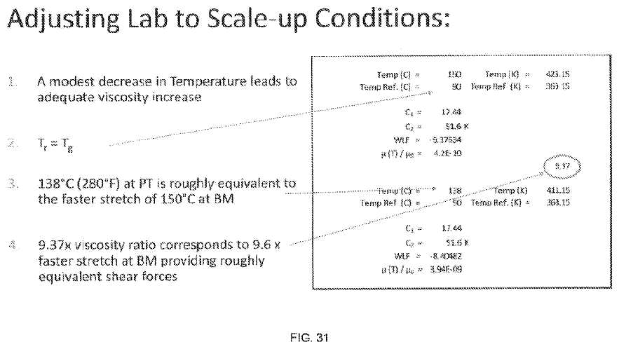

In the PPL analysis, there are a number of parameters to examine vs. this Coupling Distance, First, we can examine the [LARGE,SMALL] components of the scattering signal. However, since these are dependent upon the sample thickness, they are not the intrinsic quantities that we desire, Nevertheless, because they sum to represent the Combined scattering signal, they can always be expressed as a percent of this Combined signal, and in so doing, they do indeed become intrinsic quantities. FIG. 30 shows how the [LARGE (%), SMALL (%)] are related to the Coupling Difference between various samples.

FIG. 30A and FIG. 30B are graphical representations of scatter percent by LARGE (FIG. 30A) and SMALL (FIG. 30B) centers plotted against their Coupling Distance (10¹⁵cm⁻³) for samples of ETFE. The samples are identified in the legend on the figures, and have been previously described.

In FIG. 30A and FIG. 30B, the solid bold vertical line represents the D_{coupling} for the unstretched samples taken from the average unstretched vector, and the dashed lines are its range. Here, we compute the average unstretched vector, i.e., in Eqn. (8), the Sⱼ components are the average <Uⱼ>over all the unstretched samples that we have measured. This D(0) signal of 0.26×10¹⁵cm⁻³ is thus a measure of the measurement uncertainty of the Coupling Distance quantity. It is clear that with processing, this D_{coupling} is significantly greater than D(0).

Since SMALL (%)=100−LARGE (%), we do not actually need to show the individual plots. We do so however, because it is instructive to visually examine the trends in each. We found previously that the SMALL centers greatly dominate the scattering for the unstretched state, and that with stretching, scattering by the SMALL centers falls, and so scattering by the LARGE centers grows. As these SMALL centers reduce in importance, the Coupling Distance increases in magnitude. For the Set-A2 to A4 samples, all made starting from 500 μm thick material from AGC, a logarithmic trend shows a reasonably good correlation ®²=0.64), and for the Set-N1 and N2 samples, 300 μm thick slabs made by Nowofol from 3M/Dyneon ETFE material, their correlation is very good ®²=0.84). We use a log-trend line since we expect that the values must in some way asymptotically approach some limiting value. For the 100 μm thick samples, although they appear to be somewhat more scattered, quite a few of their points fail very near to either the 500 μm thick trend or to the 300 μm thick trend.

In conclusion, we have found a formal relationship between the molecular structure as represented by the Coupling Distance of the NIR combination bands, and the nano-scale structure that defines the meso-scale of the scattering centers. This is especially evident when starting from the thicker 300 and 500 μm slabs and stretching to thinner slabs. What this means is that the IRO structure of the molecules that make up the polymer will rearrange into specific orientations and positions uponstretching. These molecular changes then lead to enhanced coupling between the (CH₂) and (CF₂) groups, and this then leads to structures that reduce the SMALL scattering while enhancing the LARGE scattering in such a way as to reduce the overall Combined scattering known as Haze.

### Lab Scale to Production Scale

In addition to the foregoing, we have successfully demonstrated that low haze ETFE (herein designated cETFE) can be made on a production scale machine. Clear ETFE film was produced by stretching a thick film of ETFE in accordance with the principles of the invention on a production scale stretching device on the premises of Parkinson Technologies, Inc., Rhode Island.

Lab scale conditions can be replicated using time-temperature superposition to scale-up to production level. For reasons that will be described hereinbelow, the temperature T in the Stretching Zone of the Parkinson Technologies Pilot Line (herein designated “PT”) is decreased so that the viscosity of the ETFE material is increased by 9,6×, there is direct correspondence with the temperature (150° C.) used in the laboratory line. The Williams-Landel-Fery Equation (or WLF Equation) is an empirical equation associated with time—temperature superposition and is used herein for guidance. See, Williams, et al., “The Temperature Dependence of Relaxation Mechanisms in Amorphous Polymers and Other Glass-forming Liquids,”J. Amer. Chem. Soc., Vol. 77, No. 14, pages 3701-3707 (1955).

The WLF equation is usually used for polymer melts or other fluids that have a class transition temperature.

μ(T)=μ₀10^{(-C1(T-Tr)/(C2+(T-Tr)} (Eqn. 9)

where T-temperature, C₁, C₂, Tᵣ, and μ₀ are empiric parameters which in this case is C₁˜17.44 and C₂˜51.6 K.

Table 6 shows a comparison of the production scale pilot line (PT) parameters, such as line speed, and residence time of the film in the preheat and stretch zones, as compared to the laboratory scale (BM) parameters for a BM stretch speed of 100%/sec for a TD stretch of 3×.

TABLE 6
Comparison of the production scale pilot line parameters
as compared to the laboratory scale parameters

| | PT Line | PT Residence | BM Residence | X = |
|---|---|---|---|---|
| Zone | Length (ft) | Time (sec) | Time (sec) | PT/BM |
| Preheat Oven | 13 | 13.2 | 30 | 1.04 |
| Stretch Oven | 8 | 19.2 | 2 | 9.60 |

This means that the temperature of the stretch zone for the pilot line should be such that it would increase the viscosity of the polymer 9.6× to that of the 150° C. stretch zone in the laboratory scale device.

A modest decrease in temperature (T) causes an adequate increase in viscosity. For example, 138° C. at PT is roughly equivalent to the faster stretch of 150° C. at BM In this example, 9.37× viscosity ratio (X) corresponds to 9.6× faster stretch at BM and provides roughly equivalent shear forces. FIG. 31 shows the empirical parameters for the WLF equation for this particular experiment.

### See Table 7 in Appendix

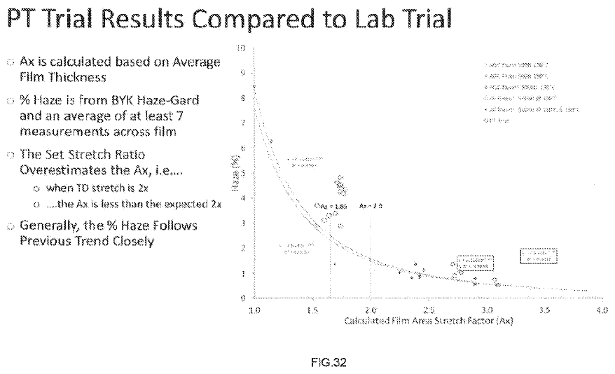

FIG. 32 is a graphical representation of Haze (%) versus the calculated film Area Stretch Factor (Ax) which show that the laboratory scale results are approximately equivalent to the pilot scale, and thus, the experiments results and conclusions made in connection with the laboratory scale experiments apply to the scale-up.

To summarize our findings, we have discovered that cETFE having less than 1% Haze can be made for a 6.5 mil film (165.1 μm). In specific embodiments, the haze value was as low as 0.54%. The stretched films had minimal birefringence, and the heat shrink was ˜10% in MD and ˜3.3% in TD. Moreover, cETFE can be made without biaxial stretching. Uniaxial stretching in the transverse direction (TD) was adequate to produce the desired results. However, the TD stretch needs to be >2× to get a haze value of <1% Haze.

Relaxation (REL) in the stretch zone or the annealing section cause unacceptable thickness variation, and is therefore, not recommended.

Statistical analysis of the experiments conducted on the pilot line indicates that the % Haze and thickness variability are lowered with increased stretch ratio. Moreover, a faster line-speed and lower preheat-to-stretch zone temperature drop favors % Haze.

We have observed slight changes to the molecular structure as indicated by the Set-of-5 bands in the NIP region which are indicative of hydrogen-bonding (H-bonding) interactions. While not wishing to be bound by theory, such H-bonding plays an important role in defining how light scatters within the material. When the stretching process modifies the H-bonding environments by reducing the “polarizability” (Le,, the size and shape of the electron clouds), the ability to scatter light is reduced.

There are strong correlations between the set-of-5 NIR bands and the haze as quantified by PPL analysis. This demonstrates that modification of the molecular structure by stretching introduces modifications of the H-bonding environment. Modifications of the H-bonding environment will itself cause modifications to the size and shape of the local electron clouds. This is demonstrates that the ETFE films, for example, stretched in accordance with the principles of the invention, are indeed a new (or changed) material.

Although the invention has been described in terms of specific embodiments and applications, persons skilled in the art can, in light of this teaching, generate additional embodiments without exceeding the scope or departing from the spirit of the claimed invention. Accordingly, It is to be understood that the drawing and description in this disclosure are proffered to facilitate comprehension of the invention, and should not be construed to limit the scope thereof. Moreover, the technical effects and technical problems in the specification are exemplary and are not limiting. The embodiments described in the specification may have other technical effects and can solve other technical problems.

What is claimed is:

1. An ETFE film that has a final thickness of at least 150 μm or more that has been processed from an ETFE film having an initial thickness of 400 μm or more and which has been stretched to create an area stretch factor (Ax) of at least 1.65 and a haze value of less than 2% and preferably <1%.

2. The ETFE film of claim 1 wherein the initial film thickness >500 μm.

3. The ETFE film of claim 1 wherein the stretch factor is >2.

4. An ETFE film that has a final thickness of at least 150 μm or more that has been processed from an ETFE film having an initial thickness of 400 μm or more made by the process of stretching the initial ETFE to create an area stretch factor (Ax) of at least 1.65 wherein the initial polymer film is heated to its softening point and is mechanically stretched by 165-400%.

5. The ETFE film of claim 4 wherein the stretching temperature ranges from from 120° C. to 180° C., and preferably from 130° C. to 160° C.

6. The ETFE film of claim 5 wherein the initial ETFE film is pre-heated.

7. The ETFE film of claim 4 wherein the stretched film is annealed at a temperature between 120° C. and 200° C.

8. The ETFE film of claim 4 wherein the stretching is done by a tenter-frame machine continuously stretches, simultaneously in two perpendicular directions, a temperature-conditioned film of the initial ETFE film thereby imparting biaxial orientation.

9. The ETFE film of claim 4 wherein the stretching done by a tenter-frame machine in a one direction thereby imparting uniaxial orientation.

10. A method of making an ETFE film having low haze comprising the steps of:
heating an extruded film of ETFE having an initial thickness ranging from about 400 μm to 500 μm or more to a temperature between about 120° C. to 180° C., and preferably from 130° C. to 160° C.
stretching the film to have an Ax>1.65 and a final film thickness of at least about 150 μm, and preferably greater than 200 μm.

11. The method of claim 10 there is a further step of annealing the stretched film in the stretched state

12. The method of claim 11 wherein the further step of annealing is performed at a temperature between 125 and 200° C.
